(19) United States
(12) Patent Application Publication
(10) Pub. No.: US 2007/0266061 A1
(43) Pub. Date: Nov. 15, 2007

(54) Data Multiplexing System

(76) Inventors: Kenichirou Fujiyama, Tokyo (JP); Nobutatsu Nakamura, Tokyo (JP)

Correspondence Address: KATTEN MUCHIN ROSENMAN LLP, 575 MADISON AVENUE, NEW YORK, NY, 10022-2585, US

(21) Appl. No.: 11/667,181

(22) PCT Filed: Nov. 2, 2005
(86) PCT No.: PCT/JP05/20197

§ 371 Date: May 4, 2007

(30) Foreign Application Priority Data
Nov. 8, 2004 (JP) 2004-323688

(51) Int. Cl. G06F 12/00

(52) U.S. Cl. 707/204

(57) ABSTRACT

Operation information to a DBMS issued from an application (3102) operating on a primary system (3100) to middleware (3103) is acquired by acquiring means (3105) and transmitted to a backup system (3200) through a communication channel (3300) by transmitting means (3108). In the backup system (3200), the received operation information is modified by modifying means (3206) so that the operation information is suitable for the DBMS (3222) of the backup system, reproduced by reproducing means (3205), and issued to the DBMS (3222) of the backup system. With this, similarly to the data in a storage (3123) of the primary system (3100), the data in a storage (3223) of the backup system (3200) is processed, thereby realizing data multiplexing.

### APPLICABLE FIELD IN THE INDUSTRY

The present invention relates to a data multiplexing system, a data multiplexing method, and a data multiplexing program for multiplexing (duplicating) data in advance for a purpose of making provision for disappearance of data accumulated in a storage of a database.

### BACKGROUND ART

One example of the conventional data multiplexing system of this type is described in Patent document 1. Upon making a reference FIG. 1, the data multiplexing system described in Patent document 1 is configured of a an application program (hereinafter, referred to as an application) 1100 for providing a service, a database management system (hereinafter, a DBMS) 1200 for managing data necessary for processing of the application 1100, a primary disk array device 1300, a backup disk array device 1400, and a communication channel 1500 for connecting these.

The primary disk array device 1300 includes a cache 1301 for temporally recording input/output of data, a transmitter 1302 for copying cached data to transfer it to the backup disk array device 1400, a memory storage 1303 for actually filing data, and a controller 1304 for controlling these. The backup disk array device 1400 includes a cache 1401 for temporally recording input/output of data, a receiver 1402 for receiving data transferred from the primary disk array device 1300 to copy it to the cache 1401, a memory storage 1403 for actually filing data, and a controller 1404 for controlling these.

The conventional data multiplexing system having such a configuration operates as follows. That is, at the moment that the application 1100 writes data into the primary disk array device 1300 via the DBMS 1200, its data is written into the cache 1301 at first, and thereafter, is filed into the memory storage 1303. The transmitter 1302 copies data within cache 1301, and transfers it to the backup disk array device 1400 via the communication channel 1500. The data transferred to the backup disk array device 1400 is received by the receiver 1402, and is copied to caches 1401. The data copied to the caches 1401 is filed into the memory storage 1403.

Doing so allows identical data to be filed into the primary disk array device 1300 and the backup disk array device 1400. Such a data multiplexing system is generally called a mirroring system.

However, in the mirroring, a large amount of data is transferred because data of which an amount is identical to that of data actually updated (or data operation information that is proportional hereto) is transferred, which gives rise to the problem that multiplexing data necessitates the wide-bandwidth communication channel 1500, or takes much time.

Thereupon, as a data multiplexing system for solving such problems, the data multiplexing systems as disclosed in Patent document 2 and Patent document 3 are known. Upon making a reference to FIG. 2, the data multiplexing system described in Patent document 2 and Patent document 3 is configured of a primary system 2100, a backup system 2200, and a communication channel 2300 for connecting these. The primary system 2100 includes an application 2110 for providing a service, a primary DBMS 2120 for managing data necessary for processing of the application, and a memory storage 2130 for actually filing data, and the primary DBMS 2120 includes an operation log 2121 for recording operation information of data performed by the primary DBMS 2120, a transmitter 2122 for transferring the content of the operation log to the backup system 2200, and a controller 2123 for controlling these. The backup system 2200 includes a backup DBMS 2220 for managing data, and a memory storage 2230 for actually filing data, and the backup DBMS 2220 includes a receiver 2222 for receiving the operation log transferred from the primary system 2100, and a controller 2223 for controlling these.

The data multiplexing system having such a configuration operates as follows. That is, in the primary system 2100, at the moment that the application 2110 performs the operation such as writing of data into the memory storage 2130 via the primary DBMS 2120, it files its operation information into the operation log 2121. The transmitter 2122 transfers the operation information filed into the operation log 2121 to the backup system 2200 via the communication channel 2300. The receiver 2222 receives the operation information transferred to the backup system 2200. The backup DBMS 2220 performs the operation such as writing of data into the memory storage 2230 according to the received operation information.

Doing so allows identical data to be filed into the memory storage 2130 of the primary system 2100, and the memory storage 2230 of the backup system 2200. Such a data multiplexing system is generally called a replication system.

In the replication, transferring not information of “operated data” itself in the storage, but abstracted information having a less amount, being more highly-ranked “operation information to data”, allows data to be multiplexed for a short time even in a narrow communication bandwidth.

Patent document 1: JP-P2003-167684A

Patent document 2: JP-P2002-108681A

Patent document 3: JP-P2000-47919A

Disclosure of the Invention

Problems to be Solved by the Invention

As mentioned above, the replication has an advantage that data can be multiplexed even in the communication channel of which a communication bandwidth is narrow, which the mirroring does not have; however there exists the following points at issue.

The first point at issue is that a performance of the entirety of the system declines largely. The reason is that a processing performance of the DBMS declines largely in a case of causing the DBMS to additionally perform the processing for realizing the replication function because the replication is a function to be provided by the DBMS, and the DBMS, of which a processing load is high as a rule, is a component having a tendency of becoming a bottleneck most easily in the system. On the other hand, in the mirroring, no processing load is put upon the DBMS; however it takes much time for the transfer processing because an enormous data amount is transferred.

The second point at issue is that the DBMS with a replication capability is limited. The reason is that, in the DBMS that is not correspondent to the replication function, the replication cannot be performed because the replication function is a function that is specific for each DBMS. Further, even in the DBMS companions correspondent to the replication function, each of which has a different type, the replication cannot be performed because a technique of the replication (a format of an operation log, a transfer protocol, etc.) differs.

Objects of the Invention

An object of the present invention is to provide a data multiplexing system that enables data to be multiplexed without lowering a performance of the system.

Another object of the present invention is to provide a data multiplexing system that enables data to be multiplexed without setting limit to the DBMS.

Means to Solve the Problems

The first data multiplexing system of the present invention is characterized in: including: a DBMS for managing data of a storage; middleware having an interface of a standard specification and yet a function of converting an access from an application into an access to the DBMS; and acquiring means for acquiring operation information of data to the DBMS that is issued to the middleware from the application in a computer system; and multiplexing the operation information of data to the DBMS.

The second data multiplexing system of the present invention is characterized in, in the first data multiplexing system, processing data of the storage that is managed by another DBMS different from the DBMS similarly to data of the storage that is managed by the DBMS, based upon the operation information of data to the DBMS acquired by the acquiring means.

The third data multiplexing system of the present invention is characterized in, in the first data multiplexing system: including identifying means for, out of the operation information of data to the DBMS acquired by the acquiring means, identifying the operation information that is used for multiplexing; and processing data of the storage that is managed by another DBMS different from the DBMS similarly to data of the storage that is managed by the DBMS, based upon the operation information identified by the above identifying means.

The fourth data multiplexing system of the present invention is characterized in, in the first data multiplexing system: including modifying means for modifying the operation information of data to the DBMS acquired by the acquiring means so that it is suitable for operation information of data to another DBMS different from the DBMS; and processing data of the storage that is managed by the another DBMS similarly to data of the storage that is managed by the DBMS, based upon the operation information modified by the modifying means.

The fifth data multiplexing system of the present invention is characterized in, in the second to the fourth data multiplexing systems, including: verifying means for comparing two items of response information to an identical operation by the DBMS and the another DBMS; and notifying means for notifying a verification result by the above verifying means.

The sixth data multiplexing system of the present invention is characterized in that, in the second to the fifth data multiplexing systems, an operation to the storage by the DBMS based upon operation information issued to the middleware from the application is performed after confirming completion of an operation to the storage by the another DBMS based upon the operation information.

The seventh data multiplexing system of the present invention is characterized in, in the first data multiplexing system, including recording means for recording the operation information of data to the DBMS acquired by the acquiring means into a storage different from the storage.

The eighth data multiplexing system of the present invention is characterized in that, in a computer system in which a primary system and a backup system are connected via a communication channel: the primary system includes: a DBMS for managing data of a storage; middleware having an interface of a standard specification and yet a function of converting an access from an application into an access to the DBMS; acquiring means for acquiring operation information of data to the DBMS that is issued to the middleware from the application; identifying means for, out of the operation information of data to the DBMS acquired by the above acquiring means, identifying the operation information that should be transmitted to the backup system; and transmitting means for transmitting the operation information identified by the above identifying means to the backup system; and the backup system includes: another DBMS for managing data of another storage; receiving means for receiving the operation information transmitted by the transmitting means; modifying means for modifying the operation information received by the above receiving means so that it is suitable for operation information of data to the another DBMS; and reproducing means for reproducing the operation information modified by the above modifying means to issue it to the another DBMS.

The ninth data multiplexing system of the present invention is characterized in that, in a computer system in which a primary system and a backup system are connected via a communication channel: the primary system includes: a DBMS for managing data of a storage; middleware having an interface of a standard specification and yet a function of converting an access from an application into an access to the DBMS; acquiring means for acquiring operation information of data to the DBMS that is issued to the middleware from the application; identifying means for, out of the operation information of data to the DBMS acquired by the above acquiring means, identifying the operation information that should be transmitted to the backup system; modifying means for modifying the operation information identified by the above identifying means so that it is suitable for operation information of data to a backup-system-side DBMS; and transmitting means for transmitting the operation information modified by the above modifying means to the backup system; and the backup system includes: another DBMS for managing data of another storage; receiving means for receiving the operation information transmitted by the transmitting means; and reproducing means for reproducing the operation information received by the above receiving means to issue it to the another DBMS.

The tenth data multiplexing system of the present invention is characterized in that, in a computer system in which a primary system and a backup system are connected via a communication channel: the primary system includes: a DBMS for managing data of a storage; middleware having an interface of a standard specification and yet a function of converting an access from an application into an access to the DBMS; acquiring means for acquiring operation information of data to the DBMS that is issued to the middleware from the application; identifying means for, out of the operation information of data to the DBMS acquired by the above acquiring means, identifying the operation information that should be transmitted to the backup system; modifying means for modifying the operation information identified by the above identifying means so that it is suitable for a backup-system-side DBMS; and reproducing means for reproducing the operation information modified by the above modifying means to issue it to another DBMS that manages a storage of the backup system via the middleware.

The eleventh data multiplexing system of the present invention is characterized in, in the eighth to the tenth data multiplexing systems, including: verifying means for comparing response information to a data operation in the primary system and response information to a data operation in the backup system; and notifying means for notifying a verification result by the above verifying means.

The twelfth data multiplexing system of the present invention is characterized in that, in a computer system in which a primary system and a backup system are connected via a communication channel: the primary system includes: a DBMS for managing data of a storage; middleware having an interface of a standard specification and yet a function of converting an access from an application into an access to the DBMS; acquiring means for acquiring operation information of data to the DBMS that is issued to the middleware from the application; identifying means for, out of the operation information of data to the DBMS acquired by the above acquiring means, identifying the operation information that should be transmitted to the backup system; and transmitting means for transmitting the operation information identified by the above identifying means to the backup system; and the backup system includes: receiving means for receiving the operation information transmitted by the transmitting means; and recording means for recording the operation information received by the above receiving means into another storage different from the storage.

The thirteenth data multiplexing system of the present invention is characterized in, in the eighth to the twelfth data multiplexing systems: being configured of one primary system and a plurality of backup systems; and that a plurality of the backup systems file a duplication of data of one primary system, respectively.

The fourteenth data multiplexing system of the present invention is characterized in, in the eighth to the twelfth data multiplexing systems: being configured of a plurality of primary systems and one backup system; and that the one backup system collects and files duplications of data of a plurality of the primary systems.

The fifteenth data multiplexing system of the present invention is characterized in, in the eighth to the twelfth data multiplexing systems: being configured of a plurality of primary systems and a plurality of backup systems; and that each backup system collects and files duplications of data of at least two out of a plurality of the primary systems.

The sixteenth data multiplexing system of the present invention is characterized in, in the eighth to the twelfth data multiplexing systems: being configured of one primary system and a plurality of backup systems; and filing duplicated data in a chain-reaction manner such that a certain backup system files duplicated data of the primary system, another backup system further files duplicated data of its backup system, and so on.

The seventeen data multiplexing system of the present invention is characterized in, in the eighth to the twelfth data multiplexing systems: being configured of a plurality of systems; and that each of them mutually files duplicated data of the other.

The eighteen data multiplexing system of the present invention is characterized in, in the eighth to the twelfth data multiplexing systems: being configured of a plurality of systems; and that each of them mutually files a duplication of data identical to the data that the other files.

The first data multiplexing method of the present invention is characterized in: into a computer system including a DBMS for managing data of a storage, middleware having an interface of a standard specification and yet a function of converting an access from an application into an access into the DBMS is installed; acquiring means acquires operation information of data to the DBMS that is issued to the middleware from the application; and the operation information of data to the DBMS is multiplexed.

The second data multiplexing method of the present invention is characterized in, in the first data multiplexing method, processing data of the storage that is managed by another DBMS different from the DBMS similarly to data of the storage that is managed by the DBMS, based upon the operation information of data to the DBMS acquired by the acquiring means.

The third data multiplexing method of the present invention is characterized in that, in the first data multiplexing method: identifying means identifies the operation information that is used for multiplexing out of the operation information of data to the DBMS acquired by the acquiring means; and data of the storage that is managed by another DBMS different from the DBMS is processed similarly to data of the storage that is managed by the DBMS, based upon the operation information identified by the identifying means.

The fourth data multiplexing method of the present invention is characterized in that, in the first data multiplexing method: modifying means modifies the operation information of data to the DBMS acquired by the acquiring means so that it is suitable for operation information of data to another DBMS different from the DBMS; and data of the storage that is managed by the another DBMS is processed similarly to data of the storage that is managed by the DBMS, based upon the operation information modified by the modifying means.

The fifth data multiplexing method of the present invention is characterized in that, in the second to the fourth data multiplexing methods: verifying means compares two items of response information to an identical operation by the DBMS and the another DBMS; and notifying means notifies a verification result by the above verifying means.

The sixth data multiplexing method of the present invention is characterized in that, in the second to the fifth data multiplexing methods, the operation to the storage by the DBMS based upon operation information issued to the middleware from the application is performed after confirming completion of the operation to the storage by the another DBMS based upon the operation information.

The seventh data multiplexing method of the present invention is characterized in that, in the first data multiplexing method, recording means records the operation information of data to the DBMS acquired by the acquiring means into a storage different from the storage.

The first primary computer system of the present invention, which is a primary computer system that is connected to a backup system via a communication channel, is characterized in including: a DBMS for managing data of a storage; middleware having an interface of a standard specification and yet a function of converting an access from an application into an access to the DBMS; acquiring means for acquiring operation information of data to the DBMS that is issued to the middleware from the application; identifying means for, out of the operation information of data to the DBMS acquired by the above acquiring means, identifying the operation information that should be transmitted to the backup system; and transmitting means for transmitting the operation information identified by the above identifying means to the backup system.

The second primary computer system of the present invention, which is a primary computer system that is connected to a backup system via a communication channel, is characterized in including: a DBMS for managing data of a storage; middleware having an interface of a standard specification and yet a function of converting an access from an application into an access to the DBMS; acquiring means for acquiring operation information of data to the DBMS that is issued to the middleware from the application; identifying means for, out of the operation information of data to the DBMS acquired by the above acquiring means, identifying the operation information that should be transmitted to the backup system; modifying means for modifying the operation information identified by the above identifying means so that it is suitable for operation information of data to a backup-system-side DBMS; and transmitting means for transmitting the operation information modified by the above modifying means to the backup system.

The third primary computer system of the present invention, which is a primary computer system that is connected to a backup system via a communication channel, is characterized in including: a DBMS for managing data of a storage; middleware having an interface of a standard specification and yet a function of converting an access from an application into an access to the DBMS; acquiring means for acquiring operation information of data to the DBMS that is issued to the middleware from the application; identifying means for, out of the operation information of data to the DBMS acquired by the above acquiring means, identifying the operation information that should be transmitted to the backup system; modifying means for modifying the operation information identified by the above identifying means so that it is suitable for operation information of data to a backup-system-side DBMS; and reproducing means for reproducing the operation information modified by the above modifying means to issue it to another DBMS that manages the storage of the backup system via the middleware.

The fourth primary computer system of the present invention is characterized in, in the first to the third primary computer systems, including: verifying means for comparing response information to a data operation in its own system and response information to a data operation in the backup system; and notifying means for notifying a verification result by the above verifying means.

The first backup computer system of the present invention, which is a backup computer system that is connected to a primary system via a communication channel, is characterized in including: receiving means for, from the primary system, receiving operation information of data to a DBMS issued to middleware, which has an interface of a standard specification and yet a function of converting an access from an application into an access to the DBMS, from the application; another DBMS for managing data of another storage; modifying means for modifying the operation information received by the receiving means so that it is suitable for operation information of data to the another DBMS; and reproducing means for reproducing the operation information modified by the above modifying means to issue it to the another DBMS.

The second backup computer system of the present invention, which is a backup computer system that is connected to a primary system via a communication channel, is characterized in including: receiving means for, from the primary system, receiving operation information of data to a DBMS issued to middleware, which has an interface of a standard specification and yet a function of converting an access from an application into an access to the DBMS, from the application, being operation information modified so that it is suitable for operation information of data to a backup-system-side DBMS; another DBMS for managing data of another storage; and reproducing means for reproducing the operation information received by the receiving means to issue it to the another DBMS.

The third backup computer system of the present invention, which is a backup computer system that is connected to a primary system via a communication channel, is characterized in: including: a storage; and a backup-system-side DBMS; and that, in the primary system side, the backup-system-side DBMS receives operation information of data to a DBMS issued to middleware, which has an interface of a standard specification and yet a function of converting an access from an application into an access to the DBMS, from the application, being operation information modified so that it is suitable for operation information of data to the backup-system-side DBMS, reproduced by reproducing means, and issued via the middleware; and manages data of the storage.

The fourth backup computer system of the present invention, which is a backup computer system that is connected to a primary system via a communication channel, is characterized in including: receiving means for, from the primary system, receiving operation information of data to a DBMS issued to middleware, which has an interface of a standard specification and yet a function of converting an access from an application into an access to the DBMS, from the application; and recording means for recording the operation information received by the above receiving means into a storage.

Advantageous Operation

In the present invention, when the operation information of data to the DBMS is issued from the application to the middleware that has an interface of a standard specification and yet a function of converting an access from the application into an access to the DBMS, it is acquired by the acquiring means and multiplexed. That is, in a typical configuration, the operation information is applied to another DBMS different from the DBMS, and data of a database that is managed by the another DBMS is processed similarly to data of a database that is managed by the DBMS of the backup source.

Effects of the Invention

The first effect lies in a point that data can be multiplexed without lowering a performance of the system. The reason is that data can be multiplexed for a short time without necessitating a wide-bandwidth communication channel, and no processing load is put upon the DBMS because the operation information of data to the DBMS that is issued from the application to the middleware has been multiplexed, and this operation information, which has been abstracted, has a less data amount.

The second effect lies in a point that data can be multiplexed without setting limit to the DBMS. The reason is that the middleware including a standard interface that does not set limit to the application and the DBMS is installed between the application and the DBMS, and the operation information that is issued from the application to the DBMS becomes identical irrespective of the application and the DBMS.

### BRIEF DESCRIPTION OF THE DRAWINGS

FIG. 1 is a block diagram illustrating a configuration of the conventional data multiplexing system.

FIG. 2 is a block diagram illustrating another configuration of the conventional data multiplexing system.

FIG. 3 is a block diagram illustrating a configuration of a first embodiment of the present invention.

FIG. 4 is a flowchart illustrating an operation of the first embodiment of the present invention.

FIG. 5 is an explanatory view of the acquiring means in the first embodiment of the present invention.

FIG. 6 is a block diagram illustrating a 1-to-N configuration that is a modification example of the first embodiment of the present invention.

FIG. 7 is a block diagram illustrating an N-to-1 configuration that is a modification example of the first embodiment of the present invention.

FIG. 8 is a block diagram illustrating an N-to-M configuration that is a modification example of the first embodiment of the present invention.

FIG. 9 is a block diagram illustrating a chain-reaction configuration that is a modification example of the first embodiment of the present invention.

FIG. 10 is a block diagram illustrating a mutual configuration that is a modification example of the first embodiment of the present invention.

FIG. 11 is a block diagram illustrating a parallel configuration that is a modification example of the first embodiment of the present invention.

FIG. 12 is a block diagram illustrating a configuration of a second embodiment of the present invention.

FIG. 13 is a flowchart illustrating an operation of the second embodiment of the present invention.

FIG. 14 is a block diagram illustrating a configuration of a third embodiment of the present invention.

FIG. 15 is a block diagram illustrating another configuration of the third embodiment of the present invention.

FIG. 16 is a flowchart illustrating an operation of the third embodiment of the present invention.

FIG. 17 is a block diagram illustrating a configuration of a fourth embodiment of the present invention.

FIG. 18 is a flowchart illustrating an operation of the fourth embodiment of the present invention.

### DESCRIPTION OF NUMERALS

3100 primary system

3101 application server

3102 application

3103 middleware

3104 DB accessing means

3105 acquiring means

3106 identifying means

3107 identification information filer

3108 transmitting means

3109 transmission information filer

3121 database server

3122 DBMS

3123 storage

3200 backup system

3201 application server

3202 application

3203 middleware

3204 DB accessing means

3205 reproducing means

3206 modifying means

3207 modification information filer

3208 receiving means

3221 database server

3222 DBMS

3223 storage

3300 communication channel

Best Mode for Carrying out the Invention

### First Embodiment

Next, the first embodiment of the present invention will be explained in details by making a reference to the accompanied drawings.

Explanation of a Configuration

Upon making a reference to FIG. 3, the first embodiment of the present invention is configured of a primary system 3100, a backup system 3200, and a communication channel 3300 for connecting these.

The primary system 3100 includes an application server 3101 for providing a service, and a database server 3121 for providing data for this application server 3101.

The database server 3121 includes a storage 3123 for filing data, and a DBMS 3122 for managing data within this storage 3123.

The application server 3101 includes an application 3102 for providing a service, and a middleware 3103. The middleware 3103 is a program for providing a common function for a plurality of application programs, from the application 3102, which operates over the application server 3101, down. In the case of this example, the middleware 3103 includes DB accessing means 3104 for converting an access from the application 3102 into an access of the database server 3121 to the DBMS 3122, and contrarily, for converting a response from the DBMS 3122 into a response to the application 3102. As an interface with the application 3102 in the DB accessing means 3104, for example, the interface of a standard specification such as a JDBC (Java (Registered Trademark) Database Connectivity) is used. On the other hand, as an interface with the DBMS 3122 in the DB accessing means 3104, the interface specific to the above DBMS 3122 is used.

In addition hereto, the application server 3101 further includes acquiring means 3105 for receiving operation information issued from the application 3102 to the DB accessing means 3104 of the middleware 3103 for a purpose of accessing the database server 3121, identifying means 3106 for, out of the operation information acquired by this acquiring means 3105, identifying the operation information that should be transmitted to the backup system 3200, an identification information filer 3107 for filing information necessary for this identification, transmitting means 3108 for transmitting to the backup system 3200 the operation information identified as one that should be transmitted, and a transmission information filer 3109 for filing information necessary for transmission such as a transmission destination address.

The backup system 3200 includes an application server 3201, being a backup of the application server 3101, and a database server 3221, being a backup of the database server 3121.

The database server 3221 includes a storage 3223 for filing data, and a DBMS 3222 for managing data within this storage 3223. The storage 3223 and the DBMS 3222 may be entirely identical to the storage 3123 and the DBMS 3122 of the database server 3121, respectively, and may differ from the storage 3123 and the DBMS 3122 in a manufacturer and a specification, respectively.

The application server 3201 includes receiving means 3208 for receiving the operation information transmitted from the application server 3101, a modification information filer 3207 for filing modification information necessary for modifying the operation information received by this receiving means 3208, which has been originally transmitted to the DBMS 3122 of the database server 3121, to operation information correspondent to the DBMS 3222 of the database server 3221, modifying means 3206 for, based upon the modification information filed into this modification information filer 3207, modifying the operation information received by the receiving means 3206, an application 3202 similar to the application 3102, middleware 3203 having DB accessing means 3204, and reproducing means 3205 for receiving the operation information modified responding to a necessity from the modifying means 3206 to issue it to the DB accessing means 3204.

The communication channel 3300 is an arbitrary communication channel such as a bus, a serial, a parallel, a LAN, a wireless LAN, Internet, and a public channel, and further, may be a multiplexing communication channel having a plurality of these combined.

Explanation of an Operation

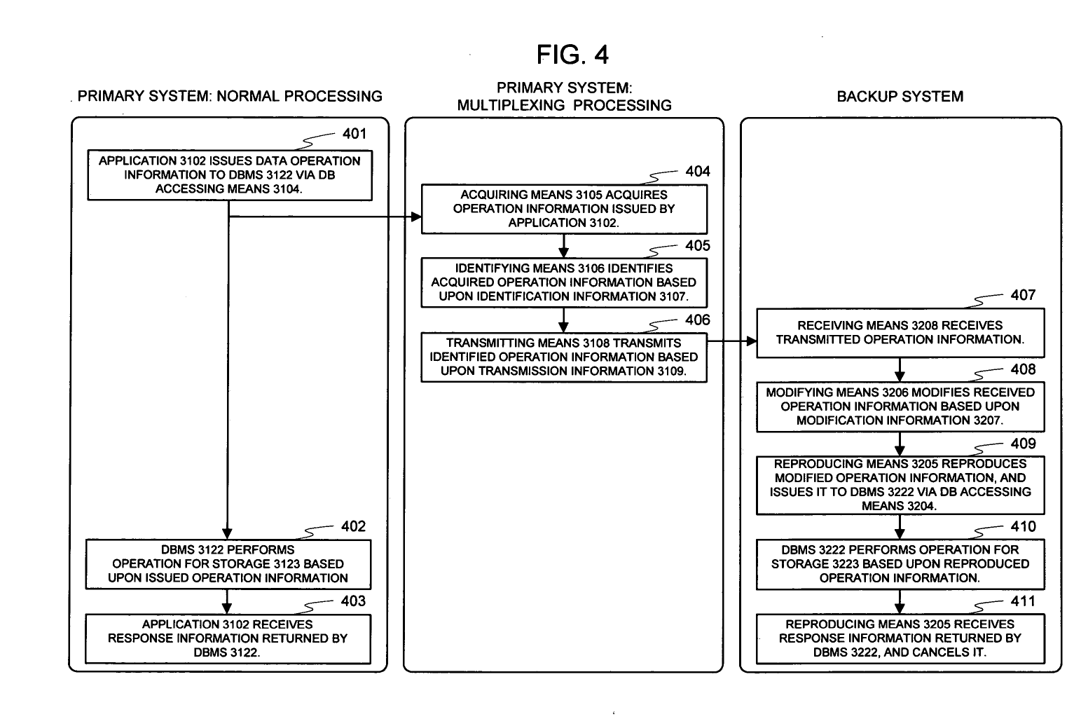

Next, an operation of this embodiment will be explained in details by making a reference to FIG. 3 and a flowchart of FIG. 4.

At first, in the primary system 3100, the application 3102 of the application server 3101, in providing a service, makes a connection to the DBMS 3122 of the database server 3121 via the DB accessing means 3104 of the middleware 3103 responding to a necessity, and issues operation information for making a reference/update to/of data necessary for processing, or the like (step 401).

The DBMS 3122 performs the operation such as a reference/update to/of filed data for the storage 3123 based upon the operation information issued from the application 3102, and returns response information, being its result (step 402).

The application 3102 receives the response information returned by the DBMS 3122 via the DB accessing means 3104 (step 403).

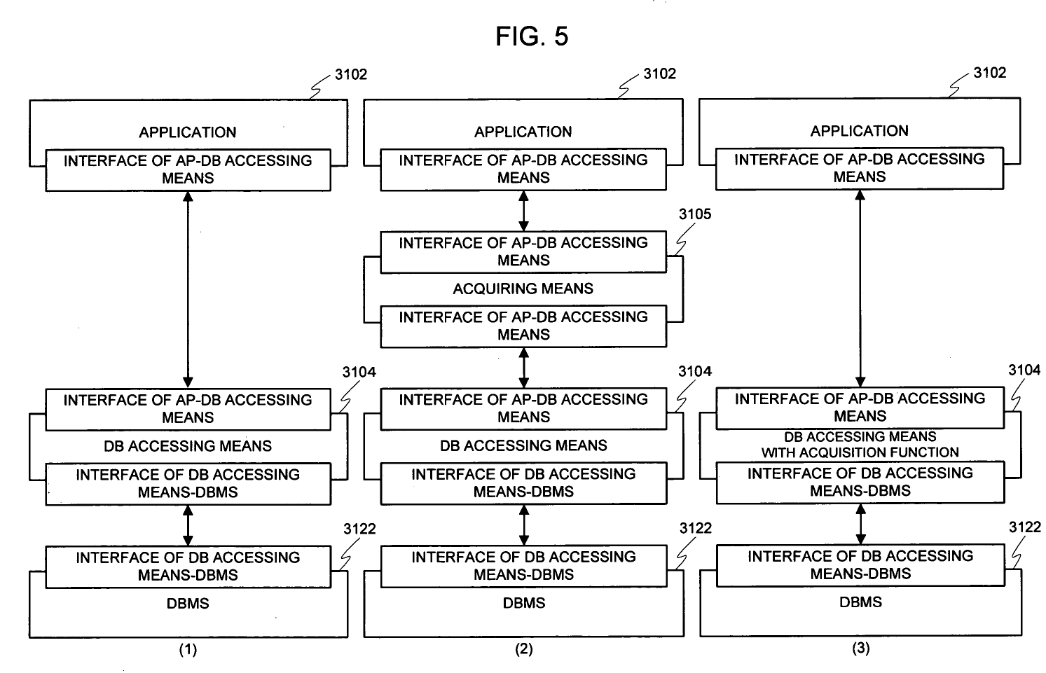

In executing the step 401, the acquiring means 3105 acquires the operation information issued to the DBMS 3122 by the application 3102 (step 404). Herein, the application 3102 and the DBMS 3122 intends to make a connection only to the DB accessing means 3104 according to the normal processing, respectively. Thus, the acquiring means 3105 acquires the operation information by transmissively trapping a connection to the DB accessing means 3104 by the application 3102 and the DBMS 3122. A specific example will be explained by making a reference to FIG. 5.

Without the acquiring means 3105, the application 3102, the DB accessing means 3104, and the DBMS 3122 are mutually connected in an interface relation as shown in FIG. 5(1). FIG. 5(2) shows an example of realizing the acquiring means 3105 with the so-called trumpet, in which the acquiring means 3105 makes a connection to the application 3102 via an interface similar to an interface of AP-DB accessing means that the DB accessing means 3104 has, and makes a connection to the DB accessing means 3104 via an interface similar to an interface of AP-DB accessing means that the application 3102 has. For this, the acquiring means 3105 appears to be similar to the DB accessing means 3104 from a view of the application 3102, and appears to be similar to the application 3102 from a view of the DB accessing means 3104, thereby enabling a connection to the DB accessing means 3104 from the application 3102 to be trapped transmissively.

FIG. 5(3) shows an example of transmissively trapping a connection to the DB accessing means 3104 from the application 3102 and the DBMS 3122 by causing the former to have a function of the acquiring means 3105. Specifically, the function of the acquiring means 3105 is packaged into a JDBC driver etc. configuring the middleware 3103.

Further, the acquisition of the operation information by acquiring means 3105 may be carried out for all applications that make a connection to the DBMS 3122 via the DB accessing means 3104, and may be carried out only for a specific application. For example, the operation to the DBMS 3122 from the application 3102 goes through a step of [connection authentication (user/connection destination)]→[operation (object/operation)], whereby only the operation information from the application authenticated by a specific user or a specific connection destination (DBMS) in the connection authentication is acquired in some case, and only the operation information from the application that performs the operation for a specific object (schemer) in the operation is acquired in some case. In this case, data of the entirety of the storage 3123 and that of the entirety of the storage 3223 are not identical to each other, and with data within the storages concerning the application that multiplexes the operation information, both of data are identical to each other. This is a modification example based upon the ground that there is no necessity for going so far as to multiplex data that is not important.

Upon making a reference to FIG. 4 again, the identifying means 3106 identifies operation information that is transmitted to the backup system 3200, out of the operation information acquired by the acquiring means 3105, based upon the identification information filed into the identification information filer 3107 (step 405). For example, the case that the identifying means 3106 transmits only an update operation so as to decrease a data amount that is transmitted, and does not transmit a reference operation, but cancels it, or the like is thinkable. In a case where the operation information that is issued from the application 3102 includes an SQL sentence (character row), if the operation is an update operation, the character rows (SQL commands) signifying an update, for example, [UPDATE] and [INSERT] are included, whereby these commands are filed into the identification information filer 3107 as identification information, and the identifying means 3106 analyzes the operation information to identify only the operation information, in which the command character row registered into the identification information has appeared, to be operation information that is transmitted to the backup system 3200, thus enabling this to be realized.

Next, the transmitting means 3108 transmits to the backup system 3200 the operation information identified as one that should be transmitted by the identifying means 3106 via the communication channel 3300 based upon the transmission information (for example, an IP address etc. of the backup system 3200) filed into the transmission information filer 3109 (step 406).

In the backup system 3200, the receiving means 3208 of the application server 3201 receives the operation information transmitted from the primary system 3100 (step 407).

Next, the modifying means 3206 analyzes the operation information received by the receiving means 3208, and modifies it responding to a necessity based upon the modification information filed into the modification information filer 3207 (step 408). As an example of the case of modification, the cases such as the following (1) to (4) are thinkable.

(1) The case that the DBMS 3122 and the DBMS 3222 differs from each other in an address for accessing Upon assuming the IP address of the DBMS 3122 to be, for example, 192.168.0.1, its IP address is included in the operation information that the application 3102, which accesses the DBMS 3122, issues. However, the address has to be converted because the DBMS 3222 is accessed in the backup system side. Thereupon, upon assuming the IP address of the DBMS 3222 to be 192.168.0.2, a correspondence relation between 192.168.0.1 and 192.168.0.2 has been filed into the modification information filer 3207, so the modifying means 3206 modifies the IP address 192.168.0.1 that is included in the operation information acquired by the receiving means 3208 to 192.168.0.2.

(2) The case that authentication information differs Upon assuming a user name/password at the moment that the application 3102 accesses the DBMS 3122 to be, for example, user1/pass1, such authentication information is included in the operation information that the application 3102, which accesses the DBMS 3122, issues. However, the backup system side necessitates such a demonstration that the application 3202 pretends to have issued the operation information. Thereupon, upon assuming a user name/password at the moment that the application 3202 accesses the DBMS 3222 to be, for example, user2/pass2, a correspondence relation between user1/pass1 and user2/pass2 has been filed into the modification information filer 3207, so the modifying means 3206 modifies the authentication information user1/pass1, which is included in the operation information acquired by the receiving means 3208, to user2/pass2.

(3) The case that a version of operation information differs

In a case where the DBMS 3122 and the DBMS 3222 differs from each other in a version of operation information, the operation information that the application 3102, which accesses the DBMS 3122, issues has to be modified to operation information having the version of the DBMS 3222. For example, in a case where the operation information that is expressed to be [DECODE(key,val1,res1,val2,res2,res3)] in the DBMS 3122 is expressed to be [CASE WHEN key=val1 THEN res1 WHEN key=val2 THEN res2 ELSE res3] in the DBMS 3222, a correspondence relation between a grammar of the former expression format and that of the latter expression format is filed into the modification information filer 3207, so the modifying means 3206 modifies the former expression format that has been included in the operation information acquired by the receiving means 3208 to the latter expression format.

(4) The case that an application to a different database schemer is desired

In a case where the database server 3121 side and the database server 3221 side differ from each other in a table name or a configuration of the database, the operation information that the application 3102, which accesses the database server 3121, issues has to be modified so that the corresponding portion of the database server 3221 is accessed. For example, in a case where a table name table1, a record name recode1, etc. of the database server 3121 side correspond to a table name table2, a record name recode2, etc. in the database server 3221, respectively, its correspondence relation has been filed into the modification information filer 3207, so the modifying means 3206 converts operation information of, for example, [UPDATE table1 SET recode1=x WHERE key1=y] acquired by the receiving means 3208 to operation information of, for example, [UPDATE table2 SET recode2=x WHERE key2=y].

Next, the reproducing means 3205 reproduces the operation information modified responding to a necessity by the modifying means 3206, and issues it to the DBMS 3222 of the database server 3221 via the DB accessing means 3204 (step 409). An interface relation between the reproducing means 3205 and each of the application 3202 and the DB accessing means 3204 is made similar to one between the acquiring means 3105 and each of the application 3102 and the DB accessing means 3104 explained in FIG. 5(2). Thus, the operation information issued from the reproducing means 3205 appears to have been issued from the application 3202 from a view of the DB accessing means 3204.

Next, the DBMS 3222 performs the operation such as an update of the filed data for the storage 3223 based upon the operation information reproduced/issued by the reproducing means 3205, and returns response information, being its result (step 410).

Finally, the reproducing means 3205 receives the response information returned by the DBMS 3222 via the DB accessing means 3204, and cancels it (step 411).

As mentioned above, data of the storage 3223 of the backup system 3200 is processed similarly to data of the storage 3123 of the primary system 3100, thereby allowing identical data to be filed into both of the storages 3123 and 3223.

For this, even though a fault occurs in the primary system 3100, and data filed into the storage 3123 is lost, data of the storage 3123 can be recovered from this data, and the service can be continued because similar data has been filed into the storage 3223 of the backup system 3200.

Or, controlling routes of the operation information and response information so that the application 3102 of the primary system 3100 makes a reference to data of the storage 3223 of the backup system 3200 enables the service to be continued.

Or, in a case where the entirety of the primary system 3100 becomes useless due to a disaster etc., the application 3202 is started, thereby enabling the service to be continued only with the backup system 3200.

Next, an effect of this embodiment will be explained.

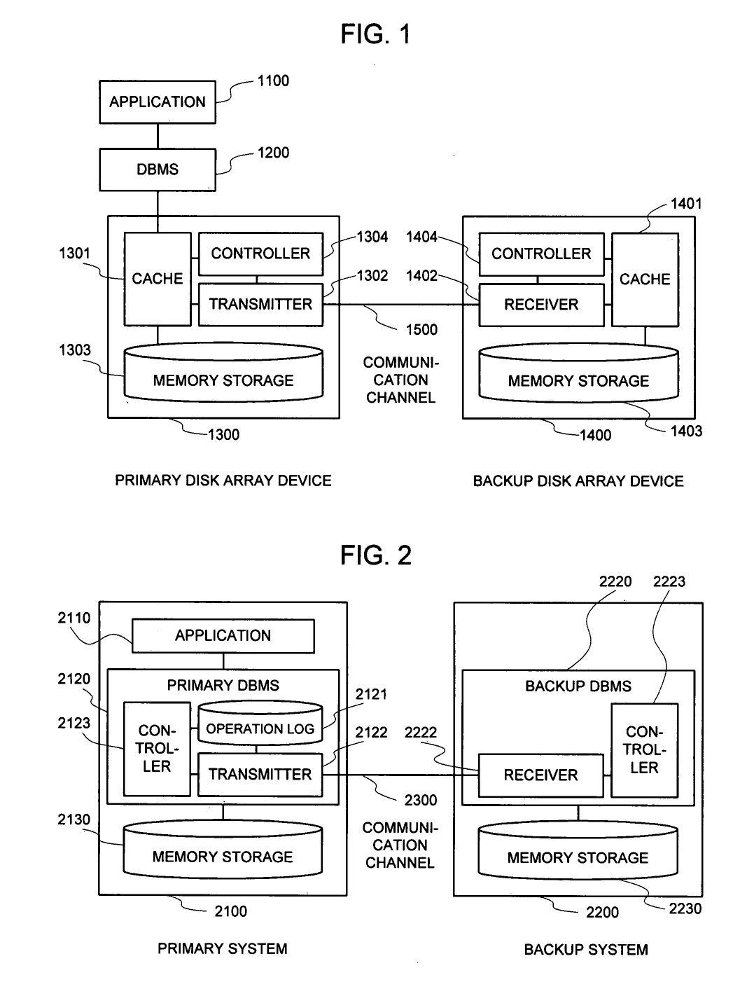

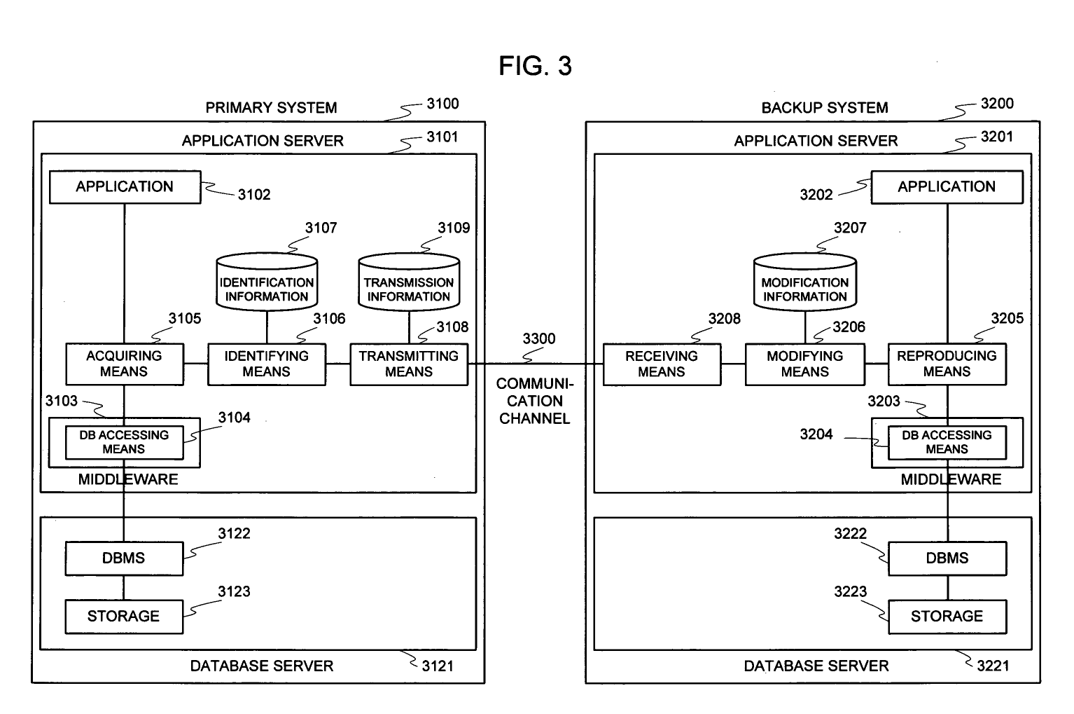

The communication channel 3300 does not require a wide bandwidth. The reason is that, in this embodiment, a data amount accompanied by the operation information that is transferred to the backup system 3200 from the primary system 3100, which is equal or so to that of the replication technique explained in FIG. 2, becomes less than the transfer data amount accompanied by the mirroring explained in FIG. 1 because simultaneously with processing storage data of the database server 3121 according to the operation information that is issued from the application 3102 operating under the application server 3101 of the primary system 3100, its operation information is transferred to the backup system 3200 to similarly process the storage data of the backup system 3200 side, thereby allowing multiplexing of data to be realized.

The data multiplexing can be executed without putting a load upon the processing of the DBMS. The reason is that the DBMS is not deeply engaged in the data multiplexing processing different from the case of the replication technique explained in FIG. 2.

The multi-execution for load dispersion is easy. The reason is that the application server 3101 differs from the database server 3121 in a point of easily carrying out the multi-execution for load dispersion. This enables data to be multiplexed without lowering a performance of the system.

Without incorporating an ad hoc function application by application or DBMS by DBMS, data can be multiplexed even between different DBMSs, for example, between the DBMSs that do not correspond to the replication function. The reason is that the DB accessing means 3104 of the middleware 3103 including a standard interface that does not set limit to the application or the DBMS is installed between the application and the DBMS, and the operation information that is issued from the application to the DBMS becomes identical irrespectively of the application and the DBMS.

Additionally, in this embodiment, the steps 402 and 403 are executed independently from the steps 404 to 411. That is, because of the so-called asynchronous multiplexing, the state that even though the data operation to the storage 3123 has been performed in the primary system 3100, the data operation to the storage 3223 has not been performed in the backup system 3200 is possible. For this, there is a possibility that data and data operation information just before occurrence of a fault are lost. Thereupon, the steps 402 and 403 may be executed after executing the step 411, that is, the so-called synchronous multiplexing of, after confirming completion of the data operation to the storage 3223 in the backup system 3200, performing the data operation to the storage 3123 in the primary system 3100 may be executed.

Further, in this embodiment, a 1-to-1 configuration in which one backup system was allocated to one primary system was employed; however configurations other than this are also thinkable. Several modification examples of the configuration are shown below. Additionally, each of the following modification examples is one example, and the modification is not limited hereto.

### 1) A MODIFICATION EXAMPLE 1 (1-TO-N CONFIGURATION)

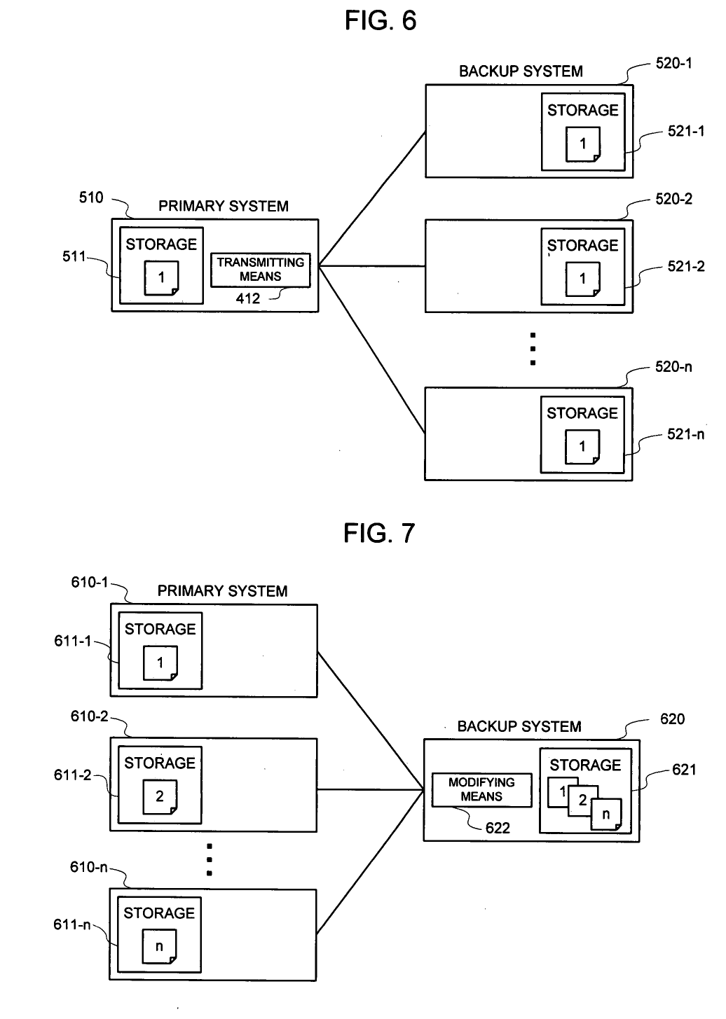

An outline of this modification example is shown in FIG. 6. Upon making a reference to FIG. 6, this modification example is configured of one primary system 510 and a plurality of backup systems 520-1, 520-2, . . . , and 520-n. Each of storages 521-1, 521-2, . . . , and 521-n of a plurality of the backup systems 520-1, 520-2, . . . , 520-n files data identical to that of a storage 511 of the primary system 510.

Transmitting means 412 of the primary system 510 (equivalent to the transmitting means 3108 of FIG. 3) transmits the operation information to each of a plurality of backup systems 520-1, 520-2, . . . , and 520-n, thereby enabling this modification example to be realized. A transmission destination address etc. of each of the backup systems 520-1, 520-2, . . . , and 520-n is filed into the portion equivalent to the transmission information filer 3109 of FIG. 3.

In this modification example, even though a fault simultaneously occurs in a plurality of the backup systems including the primary system 510, data of the remaining backup system can be employed for recovery because the backup systems exist in plural.

### 2) A MODIFICATION EXAMPLE 2 (N-TO-1 CONFIGURATION)

An outline of this modification example is shown in FIG. 7. Upon making a reference to FIG. 7, this modification example is configured of a plurality of primary systems 610-1, 610-2, . . . , and 610-n, and one backup system 620.

Data of storages 611-1, 611-2, . . . , and 611-n of a plurality of the primary systems 610-1, 610-2, . . . , 610-n is collected into a storage 621 of the backup system 620, and duplicated.

Modifying means 622 of the backup system 620 (equivalent to the modifying means 3206 of FIG. 3) modifies items of operation information that are transmitted from a plurality of the primary systems 610-1, 610-2, . . . , 610-n so that they are applied to different regions of the storage 611, i.e. the schemers that differ for each DBMS layer, respectively, thereby enabling this modification example to be realized. The modification information as explained in the embodiment of FIG. 3 is pre-filed into the portion equivalent to the modification information filer 3207 of FIG. 3, correspondingly to information (for example, the IP address) for specifying each of the primary systems 610-1, 610-2, . . . , 610-n, and the modifying means 622 modifies the operation information based upon the modification information that corresponds to the primary system, being a transmission source of the operation information, thereby enabling such a modification to be realized.

Additionally, in this modification example, in the backup system 620, the modifying means 622 modifies the operation information; however, it is acceptable that, for the reason of the load dispersion, each of the primary systems 610-1, 610-2, . . . , 610-n includes the modifying means, which modifies the operation information in advance, and then transmits it to the backup system 620.

In this modification example, a cost of constructing the system can be reduced because there is no necessity for making up the number of the backup systems equivalent to the number of the primary systems.

### 3) A MODIFICATION EXAMPLE 3 (N-TO-M CONFIGURATION)

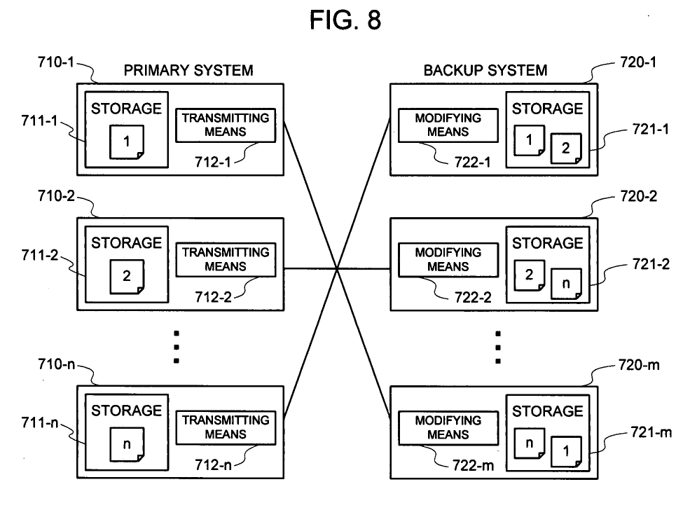

An outline of this modification example is shown in FIG. 8. Upon making a reference to FIG. 8, this modification example is configured of a plurality of primary systems 710-1, 710-2, . . . , and 710-n, and a plurality of backup systems 720-1, 720-2, . . . , and 720-m.

Transmitting means 712-1, 712-2, . . . , and 713-n of the primary system 710-1, 710-2, . . . , and 710-n (equivalent to the transmitting means 3108 of FIG. 3) transmit the operation information to at least two, out of a plurality of the backup systems 720-1, 720-2, . . . , and 720-m, respectively, and modifying means 722-1, 722-2, . . . , and 722-m (equivalent to the modifying means 3206 of FIG. 3) of the backup systems 720-1, 720-2, . . . , and 720-m modifies items of the operation information received from a plurality of the primary systems, respectively, so that they are applied to different regions of the storages 721-1, 721-2, . . . , and 721-m, i.e. the schemers that differ for each DBMS layer, respectively, thereby enabling this modification example to be realized.

The transmission destination address etc. of each of a plurality of the backup systems to which the operation information should be transmitted is filed into a transmission information filer (equivalent to the transmission information filer 3109 of FIG. 3) of each of the primary system 710-1, 710-2, . . . , and 710-n, so the transmitting means 712-1, 712-2, . . . , and 713-n make a reference hereto for transmission. Further, the modification information as explained in the embodiment of FIG. 3 is filed into the portion equivalent to the modification information filer 3207 of FIG. 3, correspondingly to the information (for example, the IP address) for specifying each of the primary systems 610-1, 610-2, . . . , 610-n, so the modifying means 722-1, 722-2, and 722-m modify the operation information based upon the modification information that corresponds to the primary system, being a transmission source of the operation information.

In this modification example, a fault-proof capability is high because a plurality of the backup systems exist like the case of the 1-to-N configuration, and decreasing the number of the backup system enables a cost of constructing the system to be reduced because data is collected and duplicated like the case of the N-to-1 configuration.

### 4) A MODIFICATION EXAMPLE 4 (CHAIN-REACTION CONFIGURATION)

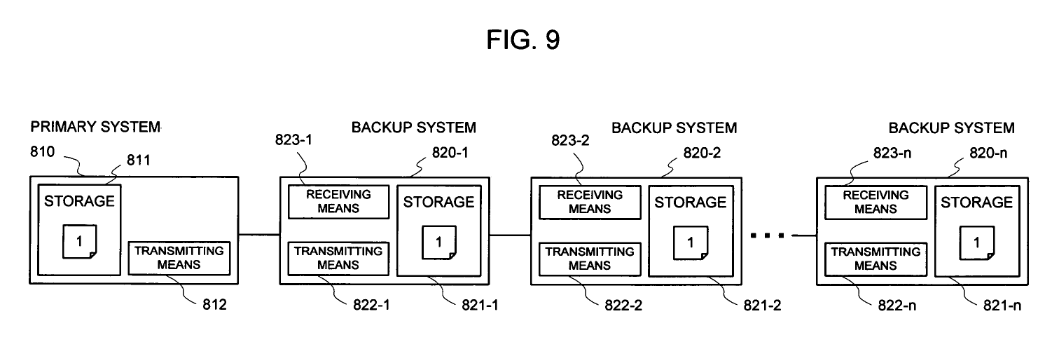

Upon making a reference to FIG. 9, this modification example is configured of one primary system 810 and at least two backup systems or more 820-1, 820-2, . . . , and 820-n connected to this primary system 810 in a longitudinal row.

Each of storages 821-1, 821-2, . . . , and 821-n of a plurality of the backup systems 820-1, 820-2, . . . , 820-n files data identical to that of a storage 811 of the primary system 810.

The backup systems 820-1, 820-2, . . . , and 820-n include not only receiving means 823-1, 823-2, . . . , and 823-n equivalent to the receiving means 3208 of FIG. 3 but also transmitting means 822-1, 822-2, . . . , and 822-n for transmitting the operation information received by this receiving means to the latter-stage backup system as communication means, respectively, and the transmission/reception is executed in a chain-reaction manner such that the primary system 810 firstly transmits the operation information to the backup system 820-1, the backup system 820-1 next transmits the received operation information to the backup system 820-2, the backup system 820-2 next transmits the received operation information to the backup system 820-3, and so on, thereby enabling this modification example to be realized.

In this modification example, a fault-proof capability is high because a plurality of the backup systems exist like the case of the 1-to-N configuration, and each system executes the transmission/reception only for one backup system at any time, thereby enabling the load to be preventing from concentrating upon one system.

### 5) A MODIFICATION EXAMPLE 5 (MUTUAL CONFIGURATION)

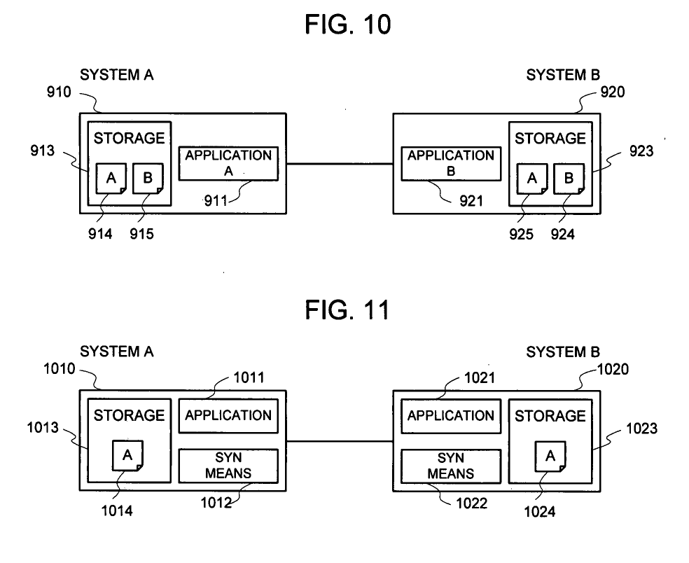

An outline of this modification example is shown in FIG. 10. Upon making a reference to FIG. 10, this modification example is configured of a system A 910 and a system B 920.

In a case of paying attention to an application A 911, the system A 910 becomes a primary system, and the system B 920 becomes a backup system. Further, in a case of paying attention to an application B 921, the system B 920 becomes a primary system, and the system A 910 becomes a backup system.

That is, in the system A 910, the application A 911 employs data A 914 filed into a storage 913 and operates. The operation information issued by the application A 911 is transmitted to the system B 920, which files data A 925, being a duplication of the data A 914, into a storage 923 according to the received operation information.

On the other hand, in the system B 920, the application B 921 employs data B 924 filed into the storage 923, and operates. The operation information issued by the application B 921 is transmitted to the system A 910, which files data B 915, being a duplication of the data B 924, into a storage 913 according to the received operation information.

This modification example can be realized by mutually regarding a partner as a backup system for operation. In this modification example, causing the application to operate even in the backup system, thereby to provide a service makes it possible to put the system to practical use without a waste. Additionally, this configuration is comprised of the two systems; however more than two is also acceptable.

### 6) A MODIFICATION EXAMPLE 6 (PARALLEL CONFIGURATION)

An outline of this modification example is shown in FIG. 11. Upon making a reference to FIG. 11, this modification example is configured of a system A 1010 and a system B 1020.

Each of the two systems, which stands on an equal footing with each other, is a primary system for the other and a backup system for the other. That is, in the system A 1010, an application 1011 employs data 1014 filed into a storage 1013, and operates. The operation information issued by the application 1011 is transmitted to the system B 1020, which files data 1024, being a duplication of the data 1014, into a storage 1023 according to the received operation information.

On the other hand, in the system B 1020, an application 1021 employs the data 1024 filed into a storage 1023, and operates. The operation information issued by the application 1021 is transmitted to the system A 1010, which files data 1014, being a duplication of the data 1024, into the storage 1013 according to the received operation information.

In addition hereto, the system A 1010 and the system B 1020 include synchronizing means 1012 and 1022, respectively, each of which does not permit the other to update date while it updates data.

This modification example can be realized by causing the two systems to operate in parallel so as to synchronize data as mentioned above.

In this modification example, causing the application to operate, thereby to provide a service even in the backup system makes it possible to put the system to practical use without a waste, and further to disperse the processing load of the application.

Additionally, this configuration is comprised of the two systems; however more than two is also acceptable.

### Second Embodiment

Next, the second embodiment of the present invention will be explained in details by making a reference to the accompanied drawings.

Explanation of Configuration

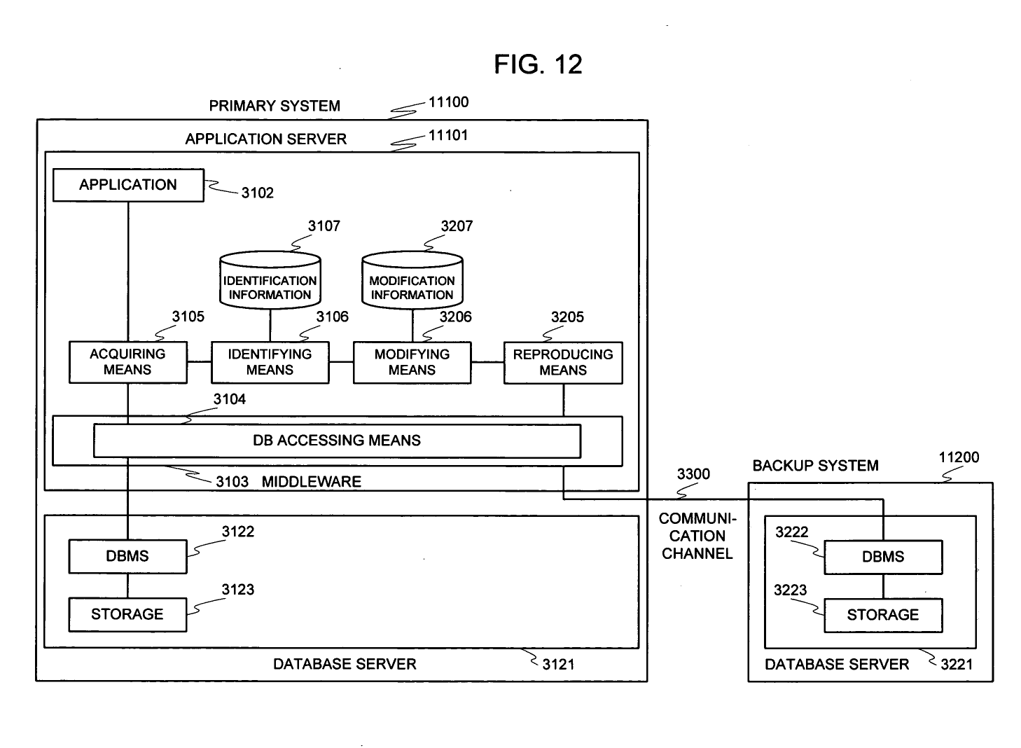

Upon making a reference to FIG. 12, this embodiment is configured of a primary system 11100, a backup system 11200, and a communication channel 3300 similar to that of the first embodiment.

The primary system 11100 includes an application server 11101 for providing a service, and a database server 3121 including a DBMS 3122 and a storage 3123 each of which is similar to that of the first embodiment.

The application server 11101 includes an application 3102, a middleware 3103 having DB accessing means 3104, acquiring means 3105, identifying means 3106, and identification information filer 3107, each of which is identical to that of the application server 3101 in the first embodiment, and further includes modifying means 3206, a modification information filer 3207, and reproducing means 3205, each of which is identical to that of the application server 3201 in the first embodiment.

The backup system 11200 includes a database server 3221 including a DBMS 3222 and a storage 3223 each of which is similar to that of the first embodiment.

Explanation of an Operation

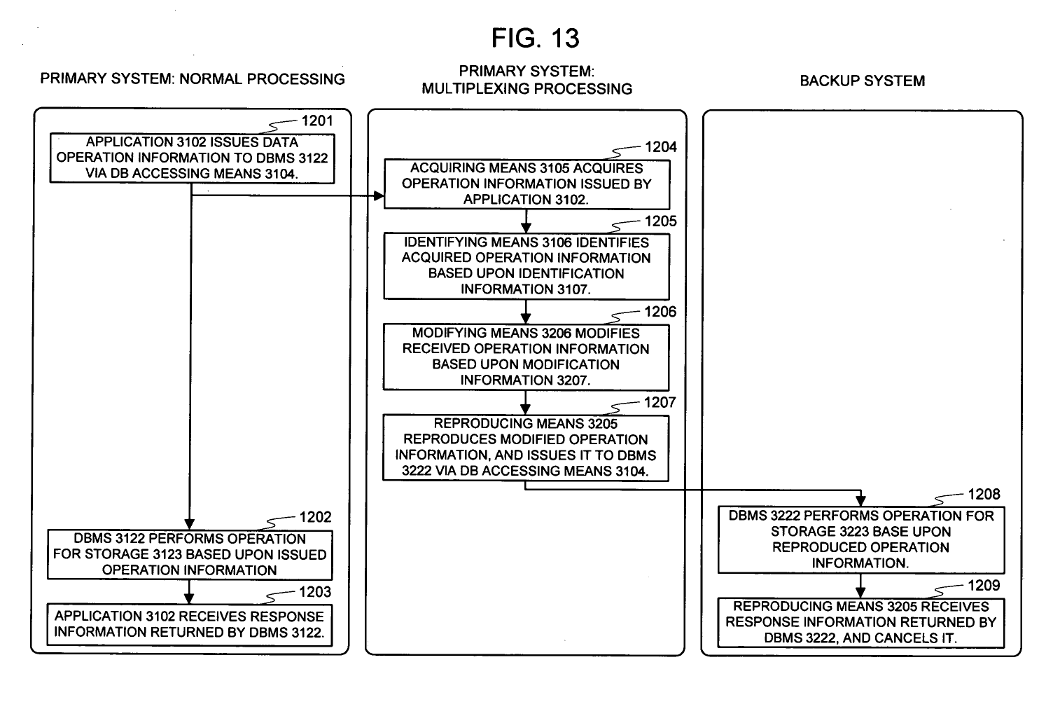

Next, an operation of this embodiment will be explained in details by making a reference to FIG. 12, and a flowchart of FIG. 13.

An operation of the application 3102, the DBMS 3122, the acquiring means 3105 and the identifying means 3106 in this embodiment shown in steps 1201 to 1205 of FIG. 13 is identical to that of the application 3102, the DBMS 3122, the acquiring means 3105 and the identifying means 3106 in the first embodiment shown in the steps 401 to 405 of FIG. 4, and so its explanation is omitted.

The modifying means 3206 modifies the operation information identified by the identifying means 3106 if necessary, based upon modification information 3207 (step 1206), and conveys it to the reproducing means 3205.

The reproducing means 3205 reproduces the operation information modified responding to a necessity by the modifying means 3206, just like the operation information issued by the application 3102, and issues it to the DBMS 3222 of the database server 3221 of the backup system 11200 via the DB accessing means 3104 (step 1207). The reproduced operation information, of which a connection address has already been modified to the DBMS 3222 by the modifying means 3206, is transmitted not to the DBMS 3122, but to the DBMS 3222 even though it goes through the identical DB accessing means 3104.

Next, the DBMS 3222 performs the operation such as an update of the filed data for the storage 3223 based upon the operation information reproduced/issued by the reproducing means 3205, and returns response information, being its result (step 1208).

Finally, the reproducing means 3205 receives the response information returned by the DBMS 3222 via the DB accessing means 3104, and cancels it (step 1209).

As a result, identical data is filed into the storage 3123 of the primary system 11100 and the storage 3223 of the backup system 11200.

Next, an effect of this embodiment will be explained.

In this embodiment, a cost of constructing the system can be reduced because the backup system does not require the application server, in addition to the effect that is obtained in the first embodiment.

Additionally, in this embodiment, the steps 1202 and 1203 are executed independently from the steps 1204 to 1209. That is, because of the so-called asynchronous multiplexing, the state that even though a data operation to the storage 3123 has been performed in the primary system 11100, a data operation to the storage 3223 has not been performed in the backup system 11200 is possible. For this, there is a possibility that data and data operation information just before occurrence of a fault are lost. Thereupon, the steps 1202 and 1203 may be executed after executing the step 1209, that is, the so-called synchronous multiplexing of, after confirming completion of the data operation to the storage 3223 in the backup system 11200, performing the data operation to the storage 3123 in the primary system 11100 may be executed.

Further, also in this embodiment, the modification similar to the modification examples 1 to 6 described in the first embodiment is possible. However, the mutual configuration and the parallel configuration require the application server in the backup system side as well.

### Third Embodiment

Next, the third embodiment of the present invention will be explained in details by making a reference to the accompanied drawings.

Explanation of a Configuration

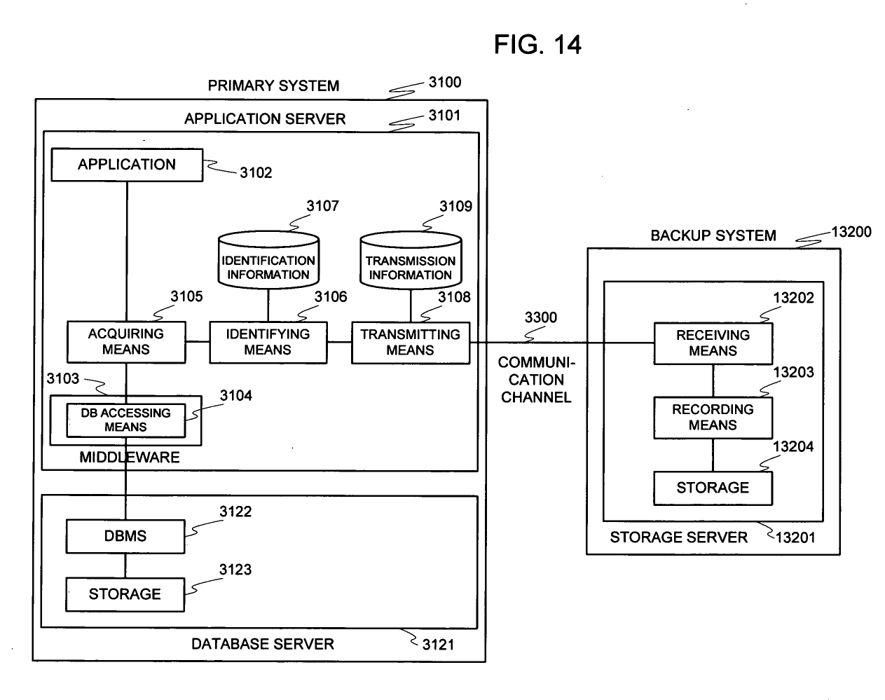

Upon making a reference to FIG. 14, a configuration of this embodiment differs from that of the first embodiment in a point of including a backup system 13200 instead of the backup system 3200, and the other component is identical.

The backup system 13200 includes a storage server 13201 for filing the operation information.

The storage server 13201 includes receiving means 13202 for receiving the operation information transmitted from an application server 3101 of a primary system 3100, recording means 13203 for recording the received operation information, and a storage 13204 for filing the operation information.

Explanation of an Operation

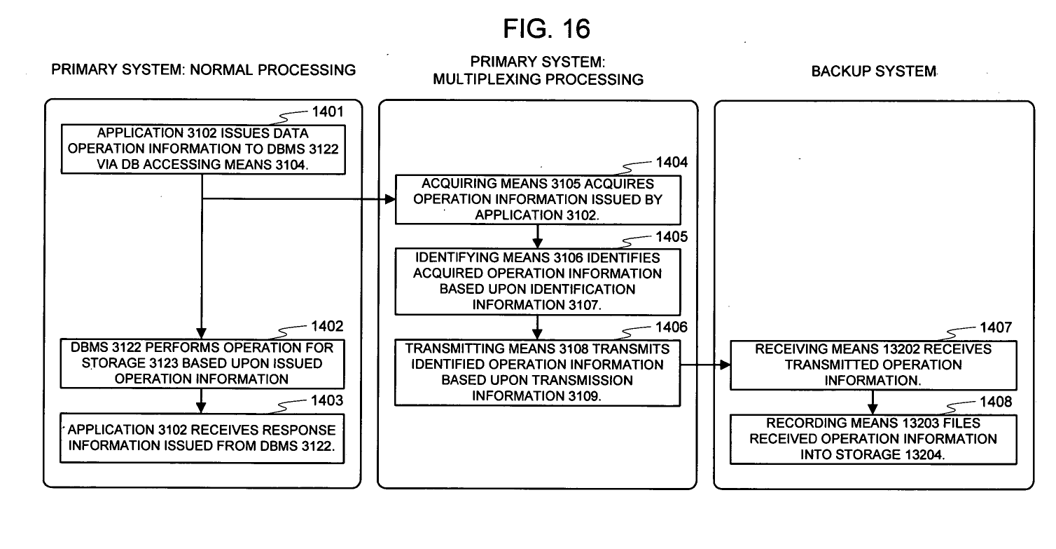

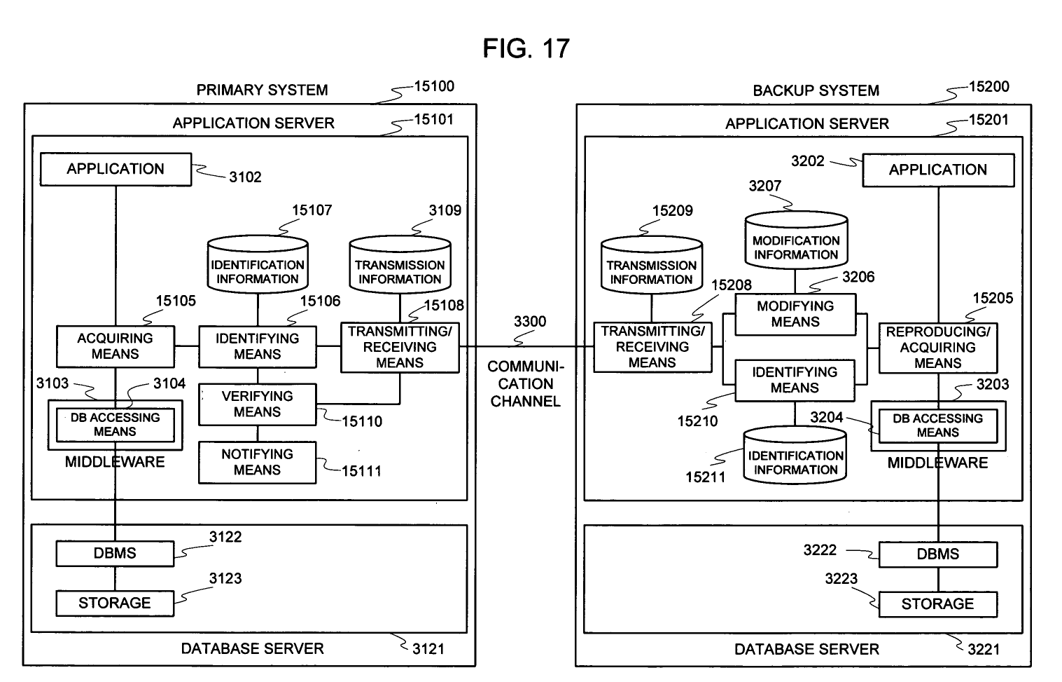

Next, an operation of this embodiment will be explained in details by making a reference to FIG. 14 and a flowchart of FIG. 16.

An operation of an application 3102, a DBMS 3122, acquiring means 3105, identifying means 3106, and transmitting means 3108 in this embodiment shown in steps 1401 to 1406 of FIG. 16 is identical to that of the application 3102, the DBMS 3122, the acquiring means 3105, the identifying means 3106, and the transmitting means 3108 in the first embodiment shown in the steps 401 to 406 of FIG. 4, and so its explanation is omitted.

In the backup system 13200, the receiving means 13202 of the storage server 13201 receives the operation information transmitted from the primary system 3100 (step 1407).

The recording means 13203 files the operation information acquired by the receiving means 13202 into the storage 13204 (step 1408).

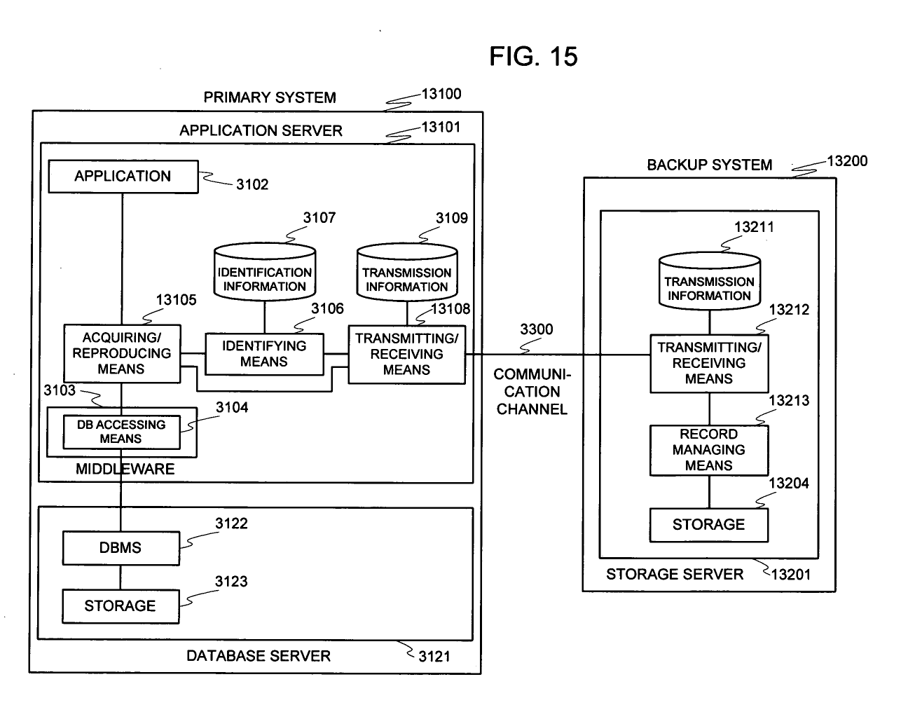

As a result, data itself filed into the storage 3123 is not multiplexed; however even though a fault occurs in the primary system 3100, and data filed into the storage 3123 is lost, reproducing the operation information to re-issue it to the DBNS 3122 makes it possible to recover data because the operation information necessary for recovering data has been filed into the storage 13204. In a case of re-issuing the operation information preserved in the storage 13204 to the DBMS 3122, the method is thinkable of transporting the storage 13204 to the primary system 3100, if transportable, to recover data. If it is not transportable, or even though it is transportable, making a configuration as shown in FIG. 15 makes it possible to remotely recover data from a backup system 13200 via a communication channel 3300. Hereinafter, an operation example in recovering data in this embodiment will be explained in details by making a reference to FIG. 15.

At first, in the backup system 13200, record managing means 13213 reads out the operation information filed into a storage 13204.

Next, transmitting/receiving means 13212 transmits the operation information read out by the record managing means 13213 to a primary system 13100 based upon a communication address of the primary system 13100 filed in a transmission information filer 13211.

In the primary system 13100, transmitting/receiving means 13108 of an application server 13101 receives the operation information transmitted from a backup system 13200, and conveys it to acquiring/reproducing means 13105.

Next, the acquiring/reproducing means 13105 reproduces the operation information received by the transmitting/receiving means 13108, just like the operation information issued by an application 3102, and issues it to a DBMS 3122 of a database server 3121 via a DB accessing means 3104.

The DBMS 3122 performs the operation such as an update of the filed data for a storage 3123 based upon the operation information reproduced/issued by the acquiring/reproducing means 13105, and returns response information, being its result.

Finally, the acquiring/reproducing means 13105 receives the response information returned by the DBMS 3122 via the DB accessing means 3104, and cancels it.

As a result, data of the storage 3123 of the primary system 13100 is recovered.

Additionally, in this embodiment of FIG. 14 and FIG. 15, the steps 1401 to 1403 are executed independently from the steps 1404 to 1408. That is, because of the so-called asynchronous multiplexing, the state that even though a data operation to the storage 3123 has been performed in the primary system 13100, the operation information has not been filed into the storage 13204 in the backup system 13200 is possible. For this, there is a possibility that the operation information just before occurrence of a fault is lost. Thereupon, the steps 1402 and 1403 may be executed after executing the step 1408, that is, the so-called synchronous multiplexing of, after confirming completion of recording the operation information to the storage 13204 in the backup system 13200, performing the data operation to the storage 3123 in the primary systems 13100 may be executed.

Further, also in this embodiment, the modification similar to the modification examples 1 to 6 described in the first embodiment is possible. However, with the parallel configuration, the modifications become similar to that of the first embodiment, if applied.

Further, a configuration may be made in which, without recording all of the operation information after beginning the data operation, the existing data multiplexing technology such as the mirroring is used together, the storage 3123 is regularly backed-up, and only the operation information performed for the storage 3123 after backing-up is recorded as a difference.

Next, an effect of this embodiment will be explained.

In this embodiment, a cost of constructing the system can be reduced because the backup system does not require the component such as the DBMS, in addition to the effect that is obtained in the first embodiment.

Further, a decline in the performance of the system can be suppressed even though the synchronous multiplexing is executed because the operation information does not have to be modified in some case, reproduced in some case, and issued in some case.

### Fourth Embodiment

Next, the fourth embodiment of the present invention will be explained in details by making a reference to the accompanied drawings.

Explanation of a Configuration

Upon making a reference to FIG. 17, the fourth embodiment of the present invention is configured of a primary system 15100, a backup system 15200, and a communication channel 3300 similar to that of the first embodiment.

The primary system 15100 includes an application server 15101 for providing a service, and a database server 3121 including a DBMS 3122 and a storage 3123 each of which is similar to that of the first embodiment.

A configuration of the application server 15101 differs from that of the application server 3100 of the first embodiment in a point of including acquiring means 15105 for acquiring both of the operation information that is issued from an application 3102, and the response information hereto from the DBMS 3122 instead of the acquiring means 3105, identifying means 15106 for, out of the operation information and response information acquired by the acquiring means 15105, identifying the operation information and response information that should be transmitted to the backup system 15200 instead of the identifying means 3106, an identification information filer 15107 for filing information necessary for identifying not only the operation information but also the response information instead of the identification information filer 3107, transmitting/receiving means 15108 having a function of both of transmission/reception instead of the transmitting means 3108, verifying means 15110 for verifying/comparing the response information, and notifying means 15111 for notifying a verification result, and other component is identical.

The backup system 15200 includes an application server 15201, being a backup of the application server 15101, and a database server 3121 including a DBMS 3222 and a storage 3223 each of which is similar to that of the first embodiment.

A configuration of the application server 15201 differs from that of the application server 3201 of the first embodiment in a point of including reproducing/acquiring means 15205 for reproducing the operation information modified by modifying means 3206 and acquiring the response information issued from the DBMS 3222 instead of the reproducing means 3205, transmitting/receiving means 15208 having a function of both of transmission/reception instead of the receiving means 3208, a transmission information filer 15209 for filing information necessary for transmitting the communication address etc. of the primary system 15100, identifying means 15210 for, out of the response information acquired by the reproducing/acquiring means 15205, identifying the response information that should be transmitted to the primary system 15100, and an identification information filer 15211 for filing information necessary for its identification, and other component is identical.

Explanation of an Operation

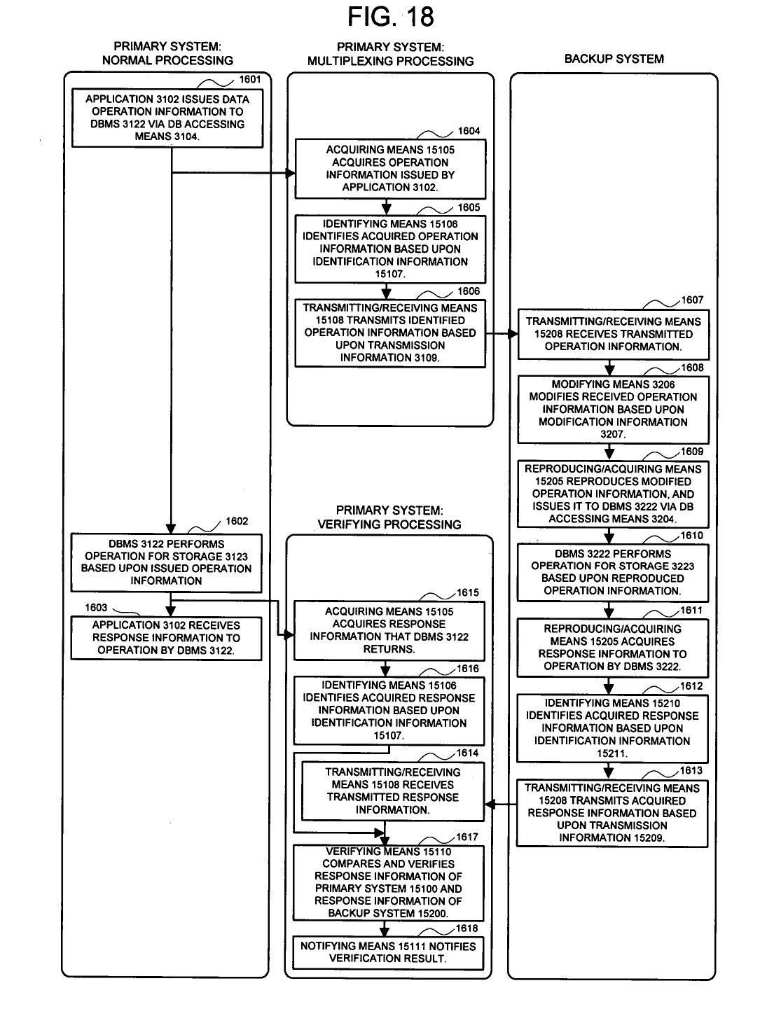

Next, an operation of this embodiment will be explained in details by making a reference to FIG. 17 and a flowchart of FIG. 18.

An operation of the application 3102, the DBMS 3122, the acquiring means 15105, the identifying means 15106, and the transmitting/receiving means 15108, the transmitting/receiving means 15208, the modifying means 3206, the reproducing/acquiring means 15205, and the DBMS 3222 in this embodiment shown in steps 1601 to 1610 of FIG. 18 is identical to that of the application 3102, the DBMS 3122, the acquiring means 3105, the identifying means 3106, transmitting means 3108, receiving means 3208, the modifying means 3206, the reproducing means 3205, and the DBMS 3222 in the first embodiment shown in the steps 401 to 410 of FIG. 4, and so its explanation is omitted.

The reproducing/acquiring means 15205 acquires the response information returned by the DBMS 3222 via DB accessing means 3204 (step 1611).

Next, the identifying means 15210 identifies the response information that is transmitted to the primary system 15100 for verification, out of the response information acquired by the reproducing/acquiring means 15205, based upon the identification information filed into the identification information filer 15211 (step 1612). For example, the case of encoding a response to the operation for transmission for a purpose of reducing a data amount that is transmitted, the case of transmitting the response information at the interval of a certain number of times, or the like is thinkable. An example of encoding the response to the operation for transmission is shown below.

For example, with a JDBC, being a DB access middleware in JAVA (registered Trademark), the response that is to be returned to the application is an object of JAVA (Registered Trademark), of which size is large, whereby this object is not be returned, but what it signifies is replaced with a mere Boolean value etc. and is returned, that is, if the operation succeeds, “truth” is returned, and if fails, “falsification” is returned. Specifically, with Statement.executeQuery (SQL), being an operation for executing SQL, a ResultSet object is returned, if the operation succeeds, and a SQLException object is returned, if it fails, whereby with the ResultSet object, it is considered that the operation has succeeded, so “truth” is transmitted, and with the SQLException object, it is considered that the operation has failed, so “falsification” is transmitted. In this case, the identification information filer 15211 has a correspondence table of indicating which object signifies “truth” and which object signifies “falsification” pre-filed. Further, there is also the case that no object is returned as a response, but a mere numerical figure etc. (primitive value) of which size is small is returned, and such a response is transmitted as it stands.

Next, the transmitting/receiving means 15208 transmits the response information, which the identifying means 15210 has identified to be one that should be transmitted, to the primary system 15100 via the communication channel 3300 based upon the communication address of the primary system 15100 filed into the transmission information filer 15209 (step 1613).

In the primary system 15100, the transmitting/receiving means 15108 receives the response information transmitted from the backup system 15200 (step 1614), and conveys it to the verifying means 15110.

Further, in the primary system 15100, at the moment that the application 3102 receives the response information of the DBMS 3122 (step 1603), the acquiring means 15105 acquires this response information (step 1615), and conveys it to the identifying means 15106. The identifying means 15106 identifies the response information necessary for verification, out of the response information acquired by the acquiring means 15105, based upon the identification information filed into the identification information filer 15107 (step 1616), and conveys it to the verifying means 15110. The method similar to that of the step 1612 is employed as an identification method.

Further, the verifying means 15110 compares and verifies the response information of the primary system 15100 identified by the identifying means 15106 and that of the backup system 15200 received by the transmitting/receiving means 15108 (step 1617).

If the response information of the primary system 15100 and the response information of the backup system 15200 coincide with each other, it is considered that the data operation in both sides has succeeded, and the data multiplexing processing has been completed normally. If they do not coincide, it is considered that abnormality has occurred in the data multiplexing processing.

Finally, the notifying means 15111 makes a notification if a result of the verification is abnormal (step 1618). As a notification destination, a system manager, means for employing this notification result to take any control, for example, means for revoking the corresponding data operation to make a retry, or the like is thinkable. Further, it is acceptable that not only the result is notified only in the case that abnormality has been detected, but also the result of verification is notified at any time.

Additionally, in this embodiment, the step 1603 is executed independently from the steps 1610 to 1618. For this, even though abnormality is detected, the processing of the application 3102 results in proceeding irrespectively thereof. Thereupon, it is acceptable that the step 1603 is executed after executing the steps 1610 to 1618, that is, after confirming that the data multiplexing processing has been normally completed, the response information is returned to the application 3102.

Additionally, in this embodiment, the response information is transmitted from the backup system 15200 to the primary system 15100 for verification; however it is acceptable that the backup system is caused to have the verifying means, and the response information issued from the primary system 15100 is also transmitted to the backup system 15200, in which the verification is made.

Or, the verification may be made in the different system or in a plurality of the systems over the communication channel 300.

In particular, with the 1-to-N configuration, the verification should be made in the backup system owing to the load dispersion because receiving and verifying the response information issued from a plurality of the backup systems in a single primary system causes a series of verifying processing to become bottlenecked.

Further, also in this embodiment, the modification similar to the modification examples 1 to 6 described in the first embodiment is possible.

Next, an effect of this embodiment will be explained.

In this embodiment, data is multiplexed more surely because comparing and verifying the response information of the DBMS makes it possible to detect normality/abnormality of the data operation, in addition to the effect that is obtained in the first embodiment.

Above, the best mode for carrying out the present invention was explained; however the present invention is not limited to the above-mentioned embodiments, and various addition modifications in addition hereto are possible. Further, the mode of having combined various embodiments is also possible. For example, the mode is thinkable of multiplexing data while making a verification by employing the fourth embodiment in the 1-to-N configuration, and further, recording the operation information of data by employing the third embodiment for the N backup systems in the chain-reaction configuration.

Further, with each component for realizing the data multiplexing function in each embodiment of the present invention, its function, needless to say, can be realized in a hardware manner, and can be realized with a computer and a program as well. The program, which is recorded into and provided for computer-readable record mediums such as a magnetic disc and a semiconductor memory, is read into the computer at the time of starting up it, or the like, and the program controls an operation of its computer, thereby causing its computer to function as a component in each of the foregoing embodiments.

How the Invention is Capable of Industrial Exploitation

The present invention is applicable to a field such as constructing the system with a high reliability for employing a DBMS to provide a service.

1. A data multiplexing system, characterized in: comprising: a DBMS for managing data of a storage; middleware having an interface between said DBMS and an application and yet a function of converting an access from said application into an access to said DBMS; and acquiring means for acquiring operation information of data to said DBMS that is issued to said middleware from said application in a computer system; and multiplexing the operation information of data to said DBMS.

2. The data multiplexing system according to claim 1, characterized in processing data of the storage that is managed by another DBMS different from said DBMS similarly to data of the storage that is managed by said DBMS, based upon the operation information of data to said DBMS acquired by said acquiring means.

3. The data multiplexing system according to claim 1, characterized in: comprising identifying means for, out of the operation information of data to said DBMS acquired by said acquiring means, identifying the operation information that is used for multiplexing; and processing data of the storage that is managed by another DBMS different from said DBMS similarly to data of the storage that is managed by said DBMS, based upon the operation information identified by said identifying means.

4. The data multiplexing system according to claim 1, characterized in: comprising modifying means for modifying the operation information of data to said DBMS acquired by said acquiring means so that it is suitable for operation information of data to another DBMS different from said DBMS; and processing data of the storage that is managed by said another DBMS similarly to data of the storage that is managed by said DBMS, based upon the operation information modified by said modifying means.

5. The data multiplexing system according to claim 2, characterized in comprising: verifying means for comparing two items of response information to an identical operation by said DBMS and said another DBMS; and notifying means for notifying a verification result by said verifying means.

6. The data multiplexing system according to of claim 2, characterized in that an operation to the storage by said DBMS based upon operation information issued to said middleware from said application is performed after confirming completion of an operation to the storage by said another DBMS based upon said operation information.

7. The data multiplexing system according to claim 1, characterized in comprising recording means for recording the operation information of data to said DBMS acquired by said acquiring means into a storage different from said storage.

8. A data multiplexing system, characterized in that, in a computer system in which a primary system and a backup system are connected via a communication channel: the primary system comprises: a DBMS for managing data of a storage; middleware having an interface between said DBMS and an application and yet a function of converting an access from said application into an access to said DBMS; acquiring means for acquiring operation information of data to said DBMS that is issued to said middleware from said application: identifying means for, out of the operation information of data to said DBMS acquired by said acquiring means, identifying the operation information that should be transmitted to the backup system; and transmitting means for transmitting the operation information identified by said identifying means to the backup system; and the backup system comprises: another DBMS for managing another storage data; receiving means for receiving the operation information transmitted by said transmitting means; modifying means for modifying the operation information received by said receiving means so that it is suitable for operation information of data to said another DBMS; and reproducing means for reproducing the operation information modified by said modifying means to issue it to said another DBMS.

9. A data multiplexing system, characterized in that, in a computer system in which a primary system and a backup system are connected via a communication channel: the primary system comprises: a DBMS for managing data of a storage; middleware having an interface between said DBMS and an application and yet a function of converting an access from said application into an access to said DBMS, acquiring means for acquiring operation information of data to said DBMS that is issued to said middleware from said application; identifying means for, out of the operation information of data to said DBMS acquired by said acquiring means, identifying the operation information that should be transmitted to the backup system; modifying means for modifying the operation information identified by said identifying means so that it is suitable for operation information of data to a backup-system-side DBMS; and transmitting means for transmitting the operation information modified by said modifying means to the backup system; and the backup system comprises: another DBMS for managing data of another storage; receiving means for receiving the operation information transmitted by said transmitting means; and reproducing means for reproducing the operation information received by said receiving means to issue it to said another DBMS.

10. A data multiplexing system, characterized in that, in a computer system in which a primary system and a backup system are connected via a communication channel: the primary system comprises: a DBMS for managing data of a storage; middleware having an interface between said DBMS and an application and yet a function of converting an access from said application into an access to said DBMS, acquiring means for acquiring operation information of data to said DBMS that is issued to said middleware from said application, identifying means for, out of the operation information of data to said DBMS acquired by said acquiring means, identifying the operation information that should be transmitted to the backup system: modifying means for modifying the operation information identified by said identifying means so that it is suitable for operation information of data to a backup-system-side DBMS; and reproducing means for reproducing the operation information modified by said modifying means to issue it to another DBMS that manages a storage of said backup system via said middleware.

11. The data multiplexing system according to claim 8, characterized in comprising: verifying means for comparing response information to a data operation in the primary system and response information to a data operation in the backup system; and notifying means for notifying a verification result by said verifying means.

12. A data multiplexing system, characterized in that, in a computer system in which a primary system and a backup system are connected via a communication channel: the primary system comprises: a DBMS for managing data of a storage; middleware having an interface between said DBMS and an application and yet a function of converting an access from said application into an access to said DBMS; acquiring means for acquiring operation information of data to said DBMS that is issued to said middleware from said application; identifying means for, out of the operation information of data to said DBMS acquired by said acquiring means, identifying the operation information that should be transmitted to the backup system; and transmitting means for transmitting the operation information identified by said identifying means to the backup system; and the backup system comprises: receiving means for receiving the operation information transmitted by said transmitting means; and recording means for recording the operation information received by said receiving means into another storage different from said storage.

13. The data multiplexing system according to claim 8 , characterized in: being configured of one primary system and a plurality of backup systems; and that a plurality of the backup systems file a duplication of data of one primary system, respectively.

14. The data multiplexing system according to claim 8 , characterized in: being configured of a plurality of primary systems and one backup system; and that the one backup system collects and files duplications of data of a plurality of the primary systems.

15. The data multiplexing system according to claim 8 , characterized in: being configured of a plurality of primary systems and a plurality of backup systems; and that each backup system collects and files duplications of data of at lease two out of a plurality of the primary systems.

16. The data multiplexing system according to claim 8 , characterized in: being configured of one primary system and a plurality of backup systems; and filing duplicated data in a chain-reaction manner such that a certain backup system files duplicated data of the primary system, another backup system further files duplicated data of its backup system, and so on.

17. The data multiplexing system according to claim 8 , characterized in: being configured of a plurality of systems; and that each of them mutually files duplicated data of the other.

18. The data multiplexing system according to claim 8 , characterized: being configured of a plurality of systems; and that each of them mutually files a duplication of data identical to the data that the other files.

19. A data multiplexing method, characterized in that: into a computer system comprising a DBMS for managing data of a storage, middleware having an interface between said DBMS and an application and yet a function of converting an access from said application into an access to said DBMS is installed; acquiring means acquires operation information of data to said DBMS that is issued to said middleware from said application; and the operation information of data to said DBMS is multiplexed.

20. The data multiplexing method according to claim 19, characterized in processing data of the storage that is managed by another DBMS different from said DBMS similarly to data of the storage that is managed by said DBMS, based upon the operation information of data to said DBMS acquired by said acquiring means.

21. The data multiplexing method according to claim 19, characterized in that: identifying means identifies the operation information that is used for multiplexing out of the operation information of data to said DBMS acquired by said acquiring means; and data of the storage that is managed by another DBMS different from said DBMS is processed similarly to data of the storage that is managed by said DBMS, based upon the operation information identified by said identifying means.

22. The data multiplexing method according to claim 19, characterized in that: modifying means modifies the operation information of data to said DBMS acquired by said acquiring means so that it is suitable for operation information of data to another DBMS different from said DBMS; and data of the storage that is managed by said another DBMS is processed similarly to data of the storage that is managed by said DBMS, based upon the operation information modified by said modifying means.

23. The data multiplexing method according to claim 20 , characterized in that: verifying means compares two items of response information to an identical operation by said DBMS and said another DBMS; and notifying means notifies a verification result by said verifying means.

24. The data multiplexing method according to claim 20 , characterized in that the operation to the storage by said DBMS based upon operation information issued to said middleware from said application is performed after confirming completion of the operation to the storage by said another DBMS based upon said operation information.

25. The data multiplexing method according to claim 19, characterized in that recording means records the operation information of data to said DBMS acquired by said acquiring means into a storage different from said storage.

26. A primary computer system that is connected to a backup system via a communication channel, characterized in comprising: a DBMS for managing data of a storage; middleware having an interface between said DBMS and an application and yet a function of converting an access from said application into an access to said DBMS; acquiring means for acquiring operation information of data to said DBMS that is issued to said middleware from said application, identifying means for, out of the operation information of data to said DBMS acquired by said acquiring means, identifying the operation information that should be transmitted to the backup system; and transmitting means for transmitting the operation information identified by said identifying means to the backup system.

27. A primary computer system that is connected to a backup system via a communication channel, characterized in comprising: a DBMS for managing data of a storage; middleware having an interface between said DBMS and an application and yet a function of converting an access from said application into an access to said DBMS; acquiring means for acquiring operation information of data to said DBMS that is issued to said middleware from said application, identifying means for, out of the operation information of data to said DBMS acquired by said acquiring means, identifying the operation information that should be transmitted to the backup system; modifying means for modifying the operation information identified by said identifying means so that it is suitable for operation information of data to a backup-system-side DBMS; and transmitting means for transmitting the operation information modified by said modifying means to the backup system.

28. A primary computer system that is connected to a backup system via a communication channel, characterized in comprising: a DBMS for managing data of a storage; middleware having an interface between said DBMS and an application and yet a function of converting an access from said application into an access to said DBMS; acquiring means for acquiring operation information of data to said DBMS that is issued to said middleware from said application; identifying means for, out of the operation information of data to said DBMS acquired by said acquiring means, identifying the operation information that should be transmitted to the backup system; modifying means for modifying the operation information identified by said identifying means so that it is suitable for operation information of data to a backup-system-side DBMS; and reproducing means for reproducing the operation information modified by said modifying means to issue it to another DBMS that manages the storage of said backup system via said middleware.

29. The primary computer system according to claim 26 , characterized in comprising: verifying means for comparing response information to a data operation in its own system and response information to a data operation in the backup system; and notifying means for notifying a verification result by said verifying means.

30. A backup computer system that is connected to a primary system via a communication channel, characterized in comprising: receiving means for, from said primary system, receiving operation information of data to a DBMS issued to middleware, which has an interface between said DBMS and an application and yet a function of converting an access from said application into an access to said DBMS, from said application; another DBMS for managing data of another storage; modifying means for modifying the operation information received by said receiving means so that it is suitable for operation information of data to said another DBMS; and reproducing means for reproducing the operation information modified by said modifying means to issue it to said another DBMS.

31. A backup computer system that is connected to a primary system via a communication channel, characterized in comprising: receiving means for, from said primary system, receiving operation information of data to a DBMS issued to middleware, which has an interface between said DBMD and an application and yet a function of converting an access from said application into an access to said DBMS, from said application, said operation information being operation information modified so that it is suitable for operation information of data to a backup-system-side DBMS; another DBMS for managing data of another storage; and reproducing means for reproducing the operation information received by said receiving means to issue it to said another DBMS.

32. A backup computer system that is connected to a primary system via a communication channel, characterized in: comprising a storage; and a backup-system-side DBMS; and that, in the primary system side, said backup-system-side DBMS receives operation information of data to said DBMS issued to middleware, which has an interface between said DBMS and an application and yet a function of converting an access from said application into an access to said DBMS, from said application, said operation information being operation information modified so that it is suitable for operation information of data to the backup-system-side DBMS, reproduced by reproducing means, and issued via said middleware; and manages data of said storage.

33. A backup computer system that is connected to a primary system via a communication channel, characterized in comprising: receiving means for, from the primary system, receiving operation information of data to a DBMS issued to middleware, which has an interface between said DBMS and an application and yet a function of converting an access from said application into an access to said DBMS, from said application; and recording means for recording the operation information received by said receiving means into a storage.

34. A program for causing a primary computer, said primary computer being connected to a backup system via a communication channel and comprising a DBMS for managing data of a storage, to function as: DB accessing means that has an interface between said DBMS and an application and yet converts an access from said application into an access to said DBMS; acquiring means for acquiring operation information of data to said DBMS that is issued to said DB accessing means from said application; identifying means for, out of the operation information of data to said DBMS acquired by said acquiring means, identifying the operation information that should be transmitted to the backup system; and transmitting means for transmitting the operation information identified by said identifying means to the backup system.

35. A program for causing a primary computer, said primary computer being connected to a backup system via a communication channel and comprising a DBMS for managing data of a storage, to function as: DB accessing means that has an interface between said DBMS and an application and yet converts an access from said application into an access into said DBMS; acquiring means for acquiring operation information of data to said DBMS that is issued to said DB accessing means from said application; identifying means for, out of the operation information of data to said DBMS acquired by said acquiring means, identifying the operation information that should be transmitted to the backup system; modifying means for modifying the operation information identified by said identifying means so that it is suitable for operation information of data to a backup-system-side DBMS; and transmitting means for transmitting the operation information modified by said modifying means to the backup system.

36. A program for causing a primary computer, said primary computer being connected to a backup system via a communication channel and comprising a DBMS for managing data of a storage, to function as: DB accessing means that has an interface between said DBMS and an application and yet converts an access from said application into an access into said DBMS; acquiring means for acquiring operation information of data to said DBMS that is issued to said DB accessing means from said application; identifying means for, out of the operation information of data to said DBMS acquired by said acquiring means, identifying the operation information that should be transmitted to the backup system; modifying means for modifying the operation information identified by said identifying means so that it is suitable for operation information of data to a backup-system-side DBMS; and reproducing means for reproducing the operation information modified by said modifying means to issue it to another DBMS that manages a storage of said backup system via said DB accessing means.

37. The program according to claim 34, causing said primary computer to function as: verifying means for comparing response information to a data operation in its own system and response information to a data operation in the backup system; and notifying means for notifying a verification result by said verifying means.

38. A program for causing a backup computer, said backup computer being connected to a primary system via a communication channel and comprising a backup-side DBMS for managing data of a storage, to function as: receiving means for, from said primary system, receiving operation information of data to said DBMS issued to middleware, which has an interface between said DBMS and an application and yet a function of converting an access from said application into an access to said DBMS, from said application; modifying means for modifying the operation information received by said receiving means so that it is suitable for operation information of data to said backup-side DBMS; and reproducing means for reproducing the operation information modified by said modifying means to issue it to said backup-side DBMS.

39. A program for causing a backup computer, said backup computer being connected to a primary system via a communication channel and comprising a backup-side DBMS for managing data of a storage, to function as: receiving means for, from said primary system, receiving operation information of data to said DBMS issued to middleware, which has an interface between said DBMS and an application and yet a function of converting an access from said application into an access to said DBMS, from said application, said operation information being operation information being modified so that it is suitable for operation information of data to the backup-system-side DBMS; and reproducing means for reproducing the operation information received by said receiving means to issue it to said backup-side DBMS.

40. A program for causing a backup computer, said backup computer being connected to a primary system via a communication channel, to function as a backup-side DBMS that: in a primary system side, receives operation information of data to a DBMS issued to middleware, which has an interface between said DBMS and an application and yet a function of converting an access from said application into an access to said DBMS, from said application, said operation information being operation information modified so that it is suitable for operation information of data to its own DBMS, reproduced by reproducing means, and issued via said middleware; and manages data of a storage.

41. A program for causing a backup computer, said backup computer being connected to a primary system via a communication channel, to function as: receiving means for, from the primary system, receiving operation information of data to a DBMS issued to middleware, which has an interface between said DBMS and an application and yet a function of converting an access from said application into an access to said DBMS, from said application; and recording means for recording the operation information received by said receiving means into a storage.
